(19) United States
(12) Patent Application Publication
(10) Pub. No.: US 2024/0325801 A1
(43) Pub. Date: Oct. 3, 2024

(54) SIDEWALL FIRE PROTECTION SPRINKLER SYSTEM AND RELATED METHODS

(71) Applicant: The Reliable Automatic Sprinkler Co. Inc., Liberty, SC (US)

(72) Inventors: Phillip FRIDAY, Santa Rosa Beach, FL (US); Matthew ROULEAU, Anderson, SC (US); Kenneth QUIST, Liberty, SC (US); Cary WEBBER, Clemson, SC (US); Steven WOLIN, Clemson, SC (US); John DESROSIER, Plymouth, MA (US)

(21) Appl. No.: 18/620,198

(22) Filed: Mar. 28, 2024

Related U.S. Application Data
(60) Provisional application No. 63/492,568, filed on Mar. 28, 2023.

(51) Int. Cl. A62C 3/06; A62C 35/68

(52) U.S. Cl. CPC A62C 3/06; A62C 35/68

(57) ABSTRACT

A fire protection sprinkler system and related method for a storage area for one or more commodities or high energy commodities, the storage area having one or more racks that each includes one or more bays. The fire protection sprinkler system includes a piping network supplied by a source of fire protection fluid. The fire protection system includes a plurality of horizontal sidewall sprinklers. Each of the plurality of horizontal sidewall sprinklers has a K-factor of 11.2 gpm/(psi)^{1/2} or greater and is positioned horizontally at a perimeter of the racks to direct the fire protection fluid into the bays. Each of the plurality of horizontal sidewall sprinklers includes a deflector that distributes the fire protection fluid to a coverage area. The fire protection sprinkler system can also include vertical sidewall sprinklers positioned vertically and include a deflector that directs the fire protection fluid horizontally into the bays.

### CROSS-REFERENCE TO RELATED APPLICATION

This application claims priority to U.S. Provisional Application No. 63/492,568, filed Mar. 28, 2023, the entire contents of which is hereby incorporated by reference.

### FIELD OF THE INVENTION

The present invention relates generally to sidewall fire protection sprinklers used in fire protection of storage buildings and warehouses, and, in particular, to sidewall fire protection sprinkler systems and related methods.

### BACKGROUND

A number of codes and standards exist that dictate fire protection sprinkler requirements. One standard is “NFPA 13: Standard for the Installation of Sprinkler Systems” (2022 edition) (“NFPA 13”). NFPA 13 is published by the National Fire Protection Association and is an industry consensus standard. Other standards include FM Global Property Loss Prevention Data Sheet 8-1 (“FM 8-1) and FM Global Property Loss Prevention Data Sheet 8-9 (“FM 8-9”). FM 8-1 and FM 8-9 are published by FM Global, an industrial property risk insurance company specializing in the “highly protected risk” category. FM 8-1 and FM 8-9 are ‘guide’ containing recommendations that may be considered best practices. FM 8-1 and FM 8-9 are not codes, and their guidelines are not regulatory requirements. Another organization that maintains standards related to fire protection sprinklers and fire protection sprinkler systems is UL Solutions (“UL”). “UL” is considered a Nationally Recognized Testing Laboratory (“NRTL”) and publishes standards for fire protection sprinklers. Of particular interest is ANSI/UL 199, “Standard for Automatic Sprinklers for Fire-Protection Service,” 13^{th} Edition, Feb. 25, 2022 (“UL 199”). UL is also considered a ‘listing agency’ as it performs product certifications and publishes a list of products that are certified according to its requirements. Similarly, “FM Approvals” performs testing and certification of fire protection sprinklers. FM Approvals publishes, “Approval Standard for Automatic Sprinkler for Fire Protection Class Number 2000,” February 2018 (“FM Class 2000”) as well as, “Approval Standard for Quick Response Storage Sprinklers for Fire Protection Class Number 2008,” February 2018 (“FM Class 2008”).

NFPA 13, FM 8-1, and FM 8-9 provide installation and protection guidelines for fire protection sprinkler systems. These guidelines establish how the fire hazard of different materials and storage configurations is to be addressed. Stored materials are classified according to the combustibility of the materials themselves and the packaging of those materials. This is defined collectively as “commodity classification.” Commodity classifications are divided into two major groups: ordinary materials and materials containing a significant amount of plastics. Commodity classifications currently recognized by NFPA 13, FM 8-1 and FM 8-9, listed in order from least combustible, or hazardous, to most combustible, or hazardous, are as follows: Class I (or Class 1), Class II (or Class 2), Class III (or Class 3), Class IV (or Class 4), and Group A Plastics. Class I commodities are essentially non-combustible products that may be placed on a wood pallet, shrink wrapped, or in a single-layer corrugated carton (e.g., steel angle iron on a wood pallet). Class II commodities are non-combustible products that are stored in combustible packaging materials such as wooden crates or boxes, multi-layered corrugated cartons and may or may not be placed on a wooden pallet. Class III commodities are products made from wood, paper, natural fibers and may or may not be placed in a carton, box, or crate, and may or may not be placed on a wooden pallet. Class IV commodities contain limited percentage of plastics. Group A plastics are considered the most hazardous of the commodity classifications excluding high hazard materials (e.g., rubber tires, flammable and combustible liquids, oxidizers, aerosols, etc.). Group A plastics are further subdivided according to whether materials are stored in cardboard cartons or ‘exposed’ (i.e., not in cardboard or wood cartons) and whether the plastic material is expanded through the introduction of gas pockets with the material structure, e.g., like many foam insulation and packaging materials, or non-expanded. The four subclassifications of Group A plastics in order from least combustible, or hazardous, to most combustible, or hazardous, are as follows: cartoned unexpanded plastics (CUP), cartoned expanded plastics (CEP), exposed unexpanded plastics (EUP), and exposed expanded plastics (EEP). NFPA 13 excludes Lithium-ion and other cells containing combustible electrolyte from its commodity classification and protection criteria. FM 8-1 includes specific guidance in Section 2.4.2 for classification and protection of Lithium-ion cells or modules.

Typical storage arrangements of materials or products include palletized storage, solid piled storage, shelf storage, bin box storage, and rack storage. Palletized storage is defined by NFPA 13 as “[s]torage of commodities on pallets or other storage aids that form horizontal spaces between tiers of storage.” Palletized storage has the advantage of not requiring racking or other material storage system, but has the disadvantage of limited storage height due to stability concerns and the inability to remove pallet loads below the top level of the palletized storage stack without removing the pallet loads above. Solid piled storage is defined by NFPA 13 as “[s]torage of commodities stacked on each other.” Shelf storage is defined by NFPA 13 as “[s]torage on structures up to and including 30 in. (750 mm) deep and separated by aisles at least 30 in. (750 mm) wide.” Bin Box storage is defined by NFPA 13 as, “[s]torage in five-sided wood, metal, or cardboard boxes with open face on the aisles in which boxes are self-supporting or supported by a structure so designed that little or no horizontal or vertical space exists around boxes.” Rack is defined in NFPA 13 as “[a]ny combination of vertical, horizontal, or diagonal members that supports stored materials.” The portion of the rack directly adjacent to an aisle being known as the “face” of the rack.

Rack storage is characterized as being in single-row, double-row, or multiple-row. NFPA 13 defines single-row racks as “[r]acks that have no longitudinal flue space and that have a depth up to 6 ft (1.8 m) with aisles having a width of at least 3.5 ft (1.1 m) between loads on racks.” NFPA 13 defines double-row racks as, “[r]acks less than or equal to 12 ft (3.7 m) in depth or single-row racks placed back-to-back having an aggregate depth up to 12 ft (3.7 m), with aisles having an aisle width of at least 3.5 ft (1.1 m) between loads on racks.” Further, NFPA 13 defines multiple-row racks as, “[r]acks greater than 12 ft (3.7 m) in depth or single- or double-row racks separated by aisles less than 3.5 ft (1.1 m) wide having an overall width greater than 12 ft (3.7 m).” FM 8-9 classifies racks as single-row when, “[t]he depth of the storage rack does not exceed 6 ft (1.8 m), and [a] minimum 4 ft (1.2 m) wide aisle separates the storage rack from adjacent storage racks”. FM 8-9 classifies racks a double-row when, “[t]he depth of the storage rack exceeds 6 ft (1.8 m), but does not exceed 12 ft (3.7 m), and [a] minimum 4 ft (1.2 m) wide aisle separates the storage rack from adjacent storage racks.” Further, FM 8-9 classifies racks as multiple-row when they do not meet the criteria for classification as single-row racks or double-row racks.

Racks may have flue spaces between contents. Flue spaces allow hot gases from a fire near the base of the rack to reach sprinklers above and water discharged from sprinklers above to reach a fire near the base of the rack. Flue spaces are defined as either “transverse,” which are parallel to the direction of loading, or “longitudinal,” which are perpendicular to the direction of loading. Sprinkler protection for rack storage may consist of sprinklers located only near the ceiling of a space, known as “ceiling-only” protection, or a combination of sprinklers near the ceiling of a space along with sprinklers located within a rack structure. Such sprinklers located within a rack structure being known as “in-rack” sprinklers.

There are a number of characteristics that influence the performance of a fire protection sprinkler in full-scale testing and in real world applications. These characteristics are the orientation, orifice size or K-factor, operating element, response time index (“RTI”), frame, and deflector.

Applicable standards include several orientations of fire protection sprinklers, including upright, pendent, and sidewall. Sidewall sprinklers being further classified as horizontal sidewall or vertical sidewall.

Upright sprinklers are intended to be installed such that the sprinkler is on top of the pipe supplying fire protection fluid (e.g., water) to the sprinkler. This results in the sprinkler deflector being positioned nearest to the ceiling immediately above the sprinkler. When an upright sprinkler activates, water initially discharges from the orifice in an upward direction until the water makes contact with the deflector. Upright sprinklers usually have an umbrella shaped deflector that shapes and redirects the water downward into a unique “discharge pattern” onto the protected area below. One drawback of upright storage fire protection sprinklers is a “pipe shadow” effect that is caused by the disruption of the sprinkler discharge pattern by the pipe supplying and immediately below the sprinkler. This phenomenon generally results in poorer performance of upright sprinklers in full-scale fire tests when compared to pendant sprinklers of an equivalent K-factor. For this reason, applicable codes and standards generally limit upright storage fire protection sprinklers to protecting comparatively less hazardous commodities under lower ceiling heights when compared to pendant sprinklers of an equivalent K-factor.

Pendant sprinklers are intended to be installed such that the sprinkler is below the pipe supplying fire protection fluid to the sprinkler. This results in the sprinkler deflector being positioned further from the ceiling and closer to the protected hazard below. When a pendant sprinkler activates, water discharges downward from the orifice until the water makes contact with the deflector. The deflector shapes and redirects the water discharge forming a unique pattern of flowing water droplets referred to as the “discharge pattern.” Pendant sprinklers are not subject to the aforementioned “pipe shadow” effect since the sprinkler is located below the pipe supplying the sprinkler.

Vertical sidewall sprinklers are intended to be installed such that the sprinkler is either below or above the pipe supplying fire protection fluid to the sprinkler. When a vertical sidewall sprinkler activates, water discharges upwards from the orifice until the water makes contact with the deflector when the sprinkler is installed above the pipe and water discharges downwards from the orifice until the water makes contact with the deflector when the sprinkler is installed below the pipe. Upon making contact with the deflector, water is directed primarily to one side of a vertical plane bisecting the sprinkler. Vertical sidewall sprinklers are intended to be installed near the perimeter of the area being protected by the sprinkler.

Horizontal sidewall sprinklers are intended to be installed such that the sprinkler is horizontally adjacent to the pipe supplying fire protection fluid to the sprinkler. When a horizontal sidewall sprinkler activates, water discharges horizontally from the orifice until the water makes contact with the deflector. Upon making contact with the deflector water is distributed horizontally away from the sprinkler as well as downwards towards the floor. Horizontal sidewall sprinklers are intended to be installed near the perimeter of the area being protected by the sprinkler.

A sprinkler is designed to have a discharge pattern tailored to the space that the sprinkler is intended to protect. The shape of the space, the location of the sprinkler within the space, and the presence of objects within the space, such as structure or building contents, influence the appropriate spray pattern. For in-rack sprinklers that are installed within rack structures, the space between the rack structure and contents stored in the racks limits the locations where sprinklers and piping supplying sprinklers can be installed. Adding space within rack structures for in-rack sprinklers and piping to be installed reduces the amount of contents that can be stored in a given volume of rack structure. Storing less contents in a rack increases the cost of the building and rack per unit of contents stored.

Building contents can influence the spray pattern of a fire protection sprinkler. For rack storage, the distance that water discharging from an in-rack sprinkler can travel away from the sprinkler is limited if the water impacts the rack structure or the contents. The closer that the contents below are to a sprinkler discharging water, the more that the distance that water discharged from the sprinkler can travel is reduced. The trajectory of the water discharged from a sprinkler must be close enough to horizontal to distribute water over the coverage area, but not so close to horizontal that excessive water travels beyond the coverage area.

Traditional sidewall sprinklers are intended to be installed 4 inches to 6 inches (100 mm to 150 mm) below the ceiling, but horizontal sidewall sprinklers may also be installed 6 inches to 12 inches (150 mm to 300 mm) or 12 inches to 18 inches (300 mm to 450 mm) below a ceiling where specially listed for such use. Traditional sidewall sprinklers are also required by NFPA 13 to be installed at least eighteen inches (18 in.) above contents below.

The orifice size, or K-factor, of a storage fire protection sprinkler determines the amount of water at a given pressure that will flow out of the sprinkler. K-factor is defined mathematically as K=Q/P^{1/2} where Q represents the flow rate in gallons per minute (GPM) from the outlet (orifice) of the sprinkler and P represents the pressure (or force) driving the water out of the sprinkler orifice and is measured in pounds per square inch (psi).

The operating element of a fire protection sprinkler is what controls the flow of water from the sprinkler. Under normal conditions, the operating element holds a seal over the sprinkler orifice to prevent water from coming out. When heat from a fire is detected, the operating element triggers and allows water to flow out of the orifice. This process is not reversible. A fire protection sprinkler that operates must be completely replaced in the systems by a new sprinkler. There are generally two types of operating element for storage fire protection sprinkler: frangible glass bulbs or metal fusible links. A frangible glass bulb operating element is a hermetically sealed glass tube filled with a fluid. When the glass bulb is heated, the fluid expands and causes the glass bulb to rupture at a designated temperature. This in turn relieves pressure on the spring-loaded orifice seal and allows water to flow freely from the sprinkler orifice. A fusible link operating element generally consists of a strut and a lever connected by a metal fusible link. The fusible link itself consist of two thin sheets of metal held together by a eutectic solder. When the fusible link is heated the solder melts at a designated temperature, allowing the two pieces of metal to separate, which causes the strut and the lever assembly to collapse. This in turn relieves pressure on the spring-loaded orifice seal and allows water to flow freely from the sprinkler orifice.

An important characteristic of a fire protection sprinklers operating element is its thermal sensitivity. Thermal sensitivity describes the rate of speed at which heat is transferred to the operating element from the air via convection and the rate of speed that heat passes through the components of the operating element as the operating element heats up via conduction. The unit of measure used to describe a fire protection sprinkler's thermal sensitivity is the response time index (RTI). The unit of measure for RTI is (m·s)^{1/2} or (ft·s)^{1/2} RTI is measured using an apparatus known as a “plunge apparatus.” A plunge apparatus consists of a heater and a fan connected to a duct that circulates air in a closed loop. Instruments and controls are used to measure and to regulate the temperature and the velocity of the air stream within the ductwork. Once the airstream has stabilized at a predetermined temperature and velocity a fire protection sprinkler is “plunged” into the airstream and a timer is started. When the sprinkler activates, the timer is stopped and the time is recorded. This process is repeated numerous times and in different orientations for each new invention. The time recorded is used in the following equations to determine the RTI:

$$R TI = T * {u}^{1 / 2} \qquad ( Equation 1 )$$

in which:

$$T = - {t}_{o} / ln [ 1 - ( {T}_{m} / ( {T}_{g} - {T}_{u} ) ] \qquad ( Equation 2 )$$

and:
tₒ: Operating time of the sprinkler [s]
Tₘ: Designated temperature rating of the sprinkler [° C., ° F.]
T_{g}: Nominal gas temperature in the test section of the apparatus [° C., ° F.]
Tᵤ: Nom. temperature of the sprinkler before being plunged into the apparatus [° C., ° F.]
u: Nom. gas velocity in the test section of the apparatus [° C., ° F.]

Applicable standards classify sprinklers according to the results of the RTI test and Equation 1. Fire protection sprinklers are classified as “standard response” or “quick response.” Standard response sprinklers have an RTI not less than 80 (m·s)½ [145 (ft·s)½] and not more than 350 (m·s)^{1/2} [630 (ft·s)½]. Quick response sprinklers have an RTI value less than 50 (m·s)½ [90 (ft·s)½], and may also be known as “fast response”. Sprinklers with RTI values greater than 50 (m·s)^{1/2} [90 (ft·s)^{1/2}] and less than 80 (m·s)^{1/2}[145 (ft·s)^{1/2}] are known as “special response.”

The development of Lithium-ion battery technology has revolutionized energy storage and mobility. Lithium-ion batteries, or Li-ion batteries, are rechargeable batteries and widely used in a variety of portable electronic devices, power tools, personal electronic devices, electric vehicles, and even spacecraft. These batteries offer several advantages over traditional batteries, such as higher energy density, longer cycle life, and lower self-discharge rates.

The history of Lithium-ion batteries can be traced back to the 1970s, when researchers at ExxonMobil developed a prototype of a rechargeable lithium battery. However, due to safety concerns and limitations in the technology at the time, the project was shelved. It was not until the 1980s that researchers at the University of Oxford, including Nobel laureate John B. Goodenough, developed the first working Lithium-ion battery. The battery used a cobalt oxide cathode and a lithium metal anode, but due to safety concerns with the use of lithium metal, it was quickly replaced with a graphite anode.

Throughout the 1990s, the technology continued to be refined, with various cathode and anode materials being developed to improve the performance and safety of the batteries. Sony commercialized the first Lithium-ion battery in the early 1990s for use in their camcorders. Sony's battery had a capacity of 0.5 Ah and used a lithium cobalt oxide cathode and a graphite anode. This marked the beginning of the widespread use of Lithium-ion batteries in consumer electronics.

The early 2000s saw a rapid expansion in the use of Lithium-ion batteries, as they became the preferred energy storage solution for portable electronic devices. In 2003, Tesla was founded with the goal of creating an electric car that could compete with gasoline-powered vehicles. The key to their success was the development of a high-performance Lithium-ion battery pack built by connecting many smaller cells. This allowed the automaker's vehicles to achieve a range of over 200 miles on a single charge. This breakthrough paved the way for the widespread adoption of electric vehicles and further accelerated the development of Lithium-ion battery technology.

Today, Lithium-ion batteries are the most common type of rechargeable battery, and are used in a wide range of applications, from consumer electronics to utility-scale energy storage. The technology has continued to evolve, with new cathode and anode materials being developed to further improve the performance and safety of the batteries. For example, researchers have developed lithium iron phosphate cathodes, which offer higher safety and longer cycle life than traditional lithium cobalt oxide cathodes. Silicon anodes are also being developed, which have the potential to increase the energy density of the batteries.

Lithium-ion batteries (Li-ion) work by using lithium ions to shuttle back and forth between the positive electrode (cathode) and the negative electrode (anode) during the charge and discharge cycles. This movement of ions creates an electrical current that can be used to power a device or recharge the battery. The basic components of a Lithium-ion battery are the cathode, anode, electrolyte, and separator. The cathode is typically made of a metal oxide, such as lithium cobalt oxide or lithium iron phosphate, and is responsible for the release of electrons during the discharge cycle. The anode, on the other hand, often made of graphite, and is responsible for the uptake of electrons during the charge cycle. The electrolyte is a liquid or a gel substance that allows the flow of ions between the cathode and anode. Finally, the separator is a thin, porous material that separates the cathode and anode, and prevents them from coming into direct contact and shorting.

During the charge cycle, the lithium ions move from the cathode to the anode, where they are stored (intercalated) in the graphite structure. At the same time, electrons are released from the cathode, and travel through an external circuit to the anode. The movement of ions and electrons is facilitated by the electrolyte, which acts as a medium for the ions to flow through.

During the discharge cycle, the process is reversed. The lithium ions move from the anode to the cathode, where they react with the metal oxide, releasing energy in the form of electrons. The electrons then flow through an external circuit, creating an electrical current that can be used to power a device. As the lithium ions move back to the cathode, they create space for new ions to move from the electrolyte to the anode during the next charge cycle.

The rate at which the ions move back and forth between the cathode and the anode determines how quickly the battery can be charged and discharged. Several factors influence this, including the type of cathode and anode materials, the electrolyte composition, and the temperature of the battery. The capacity of the battery, or the amount of energy the battery can store, is determined by the amount of lithium ions that can be stored in the anode. The voltage of the battery, or the electrical potential difference between the cathode and anode, is determined by the chemical reactions that occur at each electrode.

One of the key advantages of Lithium-ion batteries is the high energy density of such batteries, which means they can store a lot of energy in a small size and weight. Lithium-ion batteries also have a long cycle life, which means the batteries can be charged and discharged many times before their performance starts to degrade. However, like all batteries, Lithium-ion batteries have limitations, such as a limited lifespan, potential safety risks, and the need for proper disposal.

There are several common Lithium-ion battery chemistries used today, each with its own set of advantages and disadvantages. Some of the most widely used Lithium-ion battery chemistries are as follows:
Lithium Cobalt Oxide (LiCoO₂ or LCO): LCO batteries are widely used in portable electronics due to their high energy density, which means LCO batteries can store a lot of energy in a small space. However, LCO batteries have a relatively short lifespan and are prone to overheating and safety issues.
Lithium Manganese Oxide (LiMn₂O₄ or LMO): LMO batteries are commonly used in power tools and electric bikes due to their high power output and long cycle life. LMO batteries are also relatively safe, but LMO batteries have a lower energy density compared to LCO batteries.
Lithium Iron Phosphate (LiFePO₄ or LFP): LFP batteries are popular in electric vehicles and stationary energy storage systems due to their long cycle life, high power output, and good thermal stability. However, LFP batteries have a lower energy density compared to LCO batteries.
Lithium Nickel Cobalt Aluminum Oxide (LiNiCoAlO₂ or NCA): NCA batteries are commonly used in electric vehicles due to their high energy density and good thermal stability. However, NCA batteries are expensive and have a shorter lifespan compared to LFP batteries.
Lithium Nickel Manganese Cobalt Oxide (LiNiMnCoO₂ or NMC): NMC batteries are used in a wide range of applications, from portable electronics to electric vehicles, due to their high energy density, long cycle life, and good thermal stability. However, NMC batteries can be expensive and are prone to safety issues if not properly managed.

These are just a few examples of the many Lithium-ion battery chemistries available today. Each chemistry has its own unique properties and characteristics, and the choice of which chemistry to use depends on the specific application and requirements.

There are a number of other lithium battery chemistries and new developments in the world of alkali metal ion batteries. For example, sodium-ion, lithium sulfur, and other chemistry variants of Lithium-ion. In addition, the battery industry is working to develop solid state batteries, i.e., batteries without a liquid or polymer gel electrolyte.

The safety and fire hazard risks associated with lithium ion and alkali metal ion batteries are attributed to both higher energy densities and the use of flammable organic solvents as electrolyte. Lithium-ion and alkali metal ion batteries can comprise both the ignition source and fuel for a fire. The release of energy from burning batteries can lead to spread of a fire between batteries and to other contents if located within a building.

The Lithium-ion and alkali metal-ion battery manufacturing process may include the following steps:
Cathode preparation: The cathode is typically made of a lithium metal oxide, such as LMO, LCO, LFP, NMC, or NCA. The cathode material is prepared by mixing the metal oxide with a binder and a conductive material, such as carbon black, to form a paste. The paste is then coated onto a metal foil, such as aluminum, and then dried.
Anode preparation: The anode is typically made of graphite, although carbon black, lithium titanate, and silica are also used. The anode material is mixed with a binder and a conductive material to form a paste. The paste is then coated onto a metal foil, such as copper, and then dried.
Electrolyte preparation: The electrolyte is a liquid or polymer gel substance that allows the flow of ions between the cathode and anode. The electrolyte typically contains a lithium salt or other salt ion, such as lithium hexafluorophosphate (LiPF₆), dissolved in a solvent, such as a mixture of ethylene carbonate and dimethyl carbonate (EC/EMC). The electrolyte is prepared by mixing the salt and solvent together in specific ratios.
Cell assembly: The cathode, anode, and electrolyte are assembled into a cell. The cathode and anode are often separated by a microporous polyolefin material such as polyethylene or polypropylene. The separator allows the flow of ions but prevents the two electrodes from touching each other. The cell is then sealed to prevent leakage and contamination.
Cell formation: Once the cells have been sealed, they are charged and discharged several times to form a stable solid electrolyte interface (SEI) layer on the surface of the electrodes. In between charging and discharging the cells are often rested or ‘aged’. During formation, the SEI is formed by the breakdown of a small amount of the electrolyte. The SEI helps to protect the electrodes from further reactions with the electrolyte and improves the longevity and performance of the battery. Further SEI development during use of the battery can degrade its performance. The formation process can last many days or even weeks. Sub-processes in formation include charging/discharging, aging (high and normal temperature), gassing/degassing, etc. During formation cells are placed in polymer-based crates/bins (a/k/a formation trays) that generally have openings on the top, bottom and/or side for access by charging and material handling equipment. The cells travel through the formation process in these trays. Formation areas in large scale cell production facilities consist of many shelves and/or racks that resemble high-rack warehouse storage or automated storage and retrieval systems (ASRS).
Testing: Finally, the cell is tested to ensure that it meets the required specifications. The cell is tested for its capacity, voltage, internal resistance, and safety. Capacity testing involves charging the cell to its maximum capacity and then discharging it to determine how much energy it can store. Voltage testing measures the voltage of the cell under different conditions, such as during charging and discharging. Internal resistance testing measures the resistance of the cell to the flow of electrons, which can affect the efficiency of the cell. Safety testing involves exposing the cell to different environmental conditions, such as high temperature or mechanical stress, to ensure that it can withstand these conditions without entering thermal runaway and catching fire.
Battery pack assembly: Several cells are connected in series or parallel to form a battery pack. The battery pack is then placed in a casing and connected to a control circuit that regulates the flow of current in and out of the battery.
Battery Pack Testing: The battery pack is tested to ensure that it meets the required performance specifications, such as capacity, voltage, and cycle life. The battery is also tested for safety to ensure that it does not overheat or catch fire.
Distribution: Once the battery pack passes all the tests, it is ready for distribution to customers. The battery pack can be used in a wide range of applications, such as smartphones, laptops, electric vehicles, and stationary energy storage systems (ESS).

Three common geometries, or form factors of Lithium-ion and alkali metal ion battery cells are cylindrical, prismatic, and pouch. Cylindrical cells are shaped like the name and look similar to AA, C, and D cell household batteries. Cylindrical cell batteries have a positive terminal on one end and a negative terminal on the other. Common cylindrical cell sizes are 18650, 21700, and 46800, where the first two digits represent the diameter of the cell in millimeters and the last three represent the length of the cylinder in tenths of millimeters. Thus, an 18650 cell is 18 mm in diameter and 65 mm in length. Typically, the last digit to be dropped when the last digit is a zero and the cell size to be described only in whole millimeters (e.g., 2170 or 4680).

Pouch cells are formed of a polymer coated foil pouch and are typically thin and rectangular shaped. Pouch cells can have the positive and negative terminals on one end or on opposite ends. They are considered the most efficient use of space but also potentially more dangerous due to the relatively weak foil pouch coupled with cooling inefficiencies. A key difference between pouch cells and either cylindrical or prismatic cells is that pouch cells do not have a hard case and are designed to be electrically neutral, i.e., neither the positive nor the negative electrode is connected to the case. Hard case cells typically incorporate a gasket or weld seam for safe venting, whereas pouch cells are heat sealed and the seams will fail at relatively low pressures.

Thermal runaway is a condition that can occur in Lithium-ion batteries when the temperature of the battery rises to a point where the heat generated by the battery exceeds its ability to dissipate heat. This can result in a chain reaction of overheating, which can lead to a fire or explosion. Thermal runaway can be caused by a number of factors, including overcharging, over-discharging, physical damage, manufacturing defects, or exposure to high temperatures.

One strategy to mitigate thermal runaway at the cell level is by using charge interrupt devices (CIDs) and/or positive temperature coefficient (PTC) switches. For multicell battery packs, battery management systems (BMSs) are employed to protection against over-charging, over-discharging, charging at dangerous temperatures and to ensure cells and series elements are properly balanced. BMS are typically a printed circuit board (PCB) that is electrically connected to the cells within a battery pack.

Another way to prevent thermal runaway is through the use of thermal management systems, which help remove heat from the battery. Thermal management systems can include the use of convective cooling systems such as fans or heat sinks or other thermally conductive materials to transfer heat away from the battery. These systems help keep the battery within a safe temperature range, preventing the buildup of heat that can lead to thermal runaway.

The choice of battery chemistry can also have an impact on the potential for thermal runaway. Certain chemistries, such as lithium iron phosphate, have better thermal stability compared to other chemistries, making them less prone to overheating and thermal runaway. Other chemistries, such as lithium cobalt oxide, are more prone to thermal runaway due to their lower thermal stability.

Finally, proper handling and use of the battery is also critical to prevent thermal runaway. Proper handling and use can include avoiding exposure to high temperatures, avoiding physical damage, and following proper charging and discharging protocols.

Despite the precautions taken, cell thermal runaway and cell-to-cell thermal runaway propagation are risks that exist with all Lithium-ion and alkali metal ion batteries. Once the thermal runaway process starts, it can only be stopped by removing the heat from the process. The most effective way to do this is via the application of water. The method of water delivery is critical to success. The timely application of water in sufficient quantities can also prevent the spread of fire to other cells or batteries or other building contents. As the energy stored within a cell increases, the amount of energy that can be released in thermal runaway increases and the amount of water that must be applied to limit thermal runaway and the spread of fire increases.

Limited large-scale tests have been conducted to determine the fire protection requirements for Lithium-ion and alkali metal ion cells and packs. In March 2013, FM Global published a research report titled, ‘Flammability Characterization of Li-ion Batteries in Bulk Storage’. The testing and analysis focused on smaller format (i.e., 2.6 Ah) Lithium-ion batteries packaged in cardboard cartons with states of charge up to 60%. One conclusion from the report is Lithium-ion batteries in cardboard cartons can be treated as a cartoned unexpanded Group A plastic (CUP) commodity as long as the protection system precludes battery involvement by early extinguishment of the carton packaging fire. Sprinklered large-scale tests that involved the batteries were not conducted as part of the project.

In October 2016, FM Global published a research report titled, “Development of Protection Recommendations for Li-ion Battery Bulk Storage: Sprinklered Fire Test.” The report describes a large scale sprinklered test conducted with larger format (i.e., 20 Ah) “polymer” pouch cell batteries packaged in cardboard cartons with a nominal state-of-charge of 50% and follow-up intermediate scale (i.e., water application) testing. The general conclusions of the report were the similar to the earlier research of FM Global except there was limited involvement of the batteries in the large-scale test and subsequent intermediate scale testing indicated a higher degree of battery involvement could be protected by a scheme adequate for protection of CUP commodity for storage heights up to 15 ft (4.5 m) under ceiling heights up to 40 ft (12 m).

Still, this work did not assess significant involvement of Lithium-ion batteries directly and cautioned against extending the results of the testing presented beyond the specific combination of packaging, battery, and SOC tested.

To date, there is little publicly available sprinkler protection guidance based on large scale testing with significant direct battery involvement or for states of charge greater than 60%.

FM 8-1 includes limited guidance for the sprinkler protection of Lithium-ion cells or modules. For storage heights up to 15 ft (4.5 m) and ceiling heights up to 40 ft (12 m), FM 8-1 includes guidance to protect Lithium-ion cells or modules with a state of charge of 60% or less using sprinkler systems located only near the ceiling of the space. For Lithium-ion cells or modules stored in excess of 15 ft (4.5 m) in height or in excess of 60% state of charge or under ceilings exceeding 40 ft (12 m) in height above the floor, sprinklers are required to be installed near the ceiling of the space and in-rack sprinkler are required to be installed within racks storing the Lithium-ion cells or modules. The in-rack sprinklers specified in Section 2.4.2 of FM 8-1 are installed beneath horizontal barriers within the racks, such horizontal barriers being installed at vertical increments not exceeding 12 ft (3.7 m). A single row of sprinklers within the depth of the rack may be used where the depth of the rack does not exceed 5 ft (1.5 m). For racks greater than 5 ft (1.5 m) in depth but not exceeding 9 ft (2.7 m) in depth, 3 rows of sprinklers are suggested at each level of in-rack sprinklers. Such in-rack sprinklers must have a K-factor of 11.2 gpm/psi¹² (160 L/min/bar^{1/2}), nominal temperature rating of 165° F. (74° C.), be quick-response, and be FM Approved as in-rack sprinklers. FM Approved in-rack sprinklers currently include only upright sprinklers and pendent sprinklers. The in-rack sprinklers must be installed a maximum of 7 inches (175 mm) below a horizontal barrier above and a minimum of 6 inches (150 mm) above the top of the contents stored below the sprinkler. Each in-rack sprinkler is hydraulically calculated to supply a minimum of 60 gpm (227 L/min) of water upon operation. The piping to such sprinkler system is sized using hydraulic calculations to verify that the minimum water flow rate is provided to a prescribed number of sprinklers that are calculated to operate. A hydraulic calculation based on 6 operating in-rack sprinklers is recommended when one horizontal barrier level is provided. For double-row racks, three such in-rack sprinklers located near a face of the rack and three such in-rack sprinklers located in the longitudinal flue are included as operating in the hydraulic calculation. When two or more horizontal barrier levels are provided, at total of eight operating sprinklers are included in the hydraulic calculation; for double-row racks, two such in-rack sprinklers located near the face of the rack and two such in-rack sprinklers located in the longitudinal flue, on each of two levels, are included as operating in the hydraulic calculations. The in-rack sprinkler system described in FM 8-1 for the protection of Lithium-ion cells or modules requires sprinkler system piping to be installed within the rack structure and open space must be provided for the installation of pendent sprinklers or upright sprinklers. Further open space must be provided within the rack to have the recommended 6 inches (150 mm) of clearance from the sprinkler deflector to the top of the stored commodity below. In addition, when in-sprinklers installed in accordance with the protection guidelines in FM 8-1 are installed near the face of a rack, the use of upright sprinklers or pendent sprinklers means that a significant portion of the water discharged by the in-rack sprinklers will reach the aisle and not the contents in the rack that could be involved in a fire.

Particularly, when protecting contents with a significant amount of stored energy, such as Lithium-ion cells, there is a need for improved fire protection sprinkler systems that quickly provide the required quantity of water to the correct space during a fire event as well as limiting the space.

### SUMMARY

In one embodiment, a fire protection sprinkler system for a storage area for one or more commodities comprising at least one of Class I to Class IV, Group A cartoned unexpanded plastic commodities, or high energy commodities, the storage area having one or more racks that each include one or more bays. The fire protection sprinkler system comprising a piping network supplied by a source of fire protection fluid provided at the storage area, and a plurality of horizontal sidewall sprinklers. Each of the plurality of horizontal sidewall sprinklers includes a K-factor of 11.2 gpm/(psi)^{1/2} or greater and are positioned horizontally at a perimeter of the one or more racks to direct the fire protection fluid into the one or more bays. Each of the plurality of horizontal sidewall sprinklers includes a deflector, the deflector being configured to distribute the fire protection fluid to a coverage area of the storage area.

In another embodiment, a method of providing a fire protection sprinkler system for a storage area for one or more commodities comprising at least one of Class I to Class IV, Group A cartoned unexpanded plastic commodities, or high energy commodities, the storage area having one or more racks that each include one or more bays. The method comprises providing a fire protection sprinkler system that includes a piping network supplied by a source of fire protection fluid provided at the storage area, and a plurality of horizontal sidewall sprinklers. Each of the plurality of horizontal sidewall sprinklers includes a K-factor of 11.2 gpm/(psi)^{1/2} or greater and are positioned horizontally at a perimeter of the one or more racks to direct the fire protection fluid into the one or more bays. Each of the plurality of horizontal sidewall sprinklers includes a deflector, the deflector being configured to distribute the fire protection fluid to a coverage area of the storage area. The method includes installing each of the plurality of horizontal sidewall sprinklers at the storage area so that the deflector of each of the plurality of horizontal sidewall sprinklers is positioned above the one or more commodities. The installing includes connecting each of the plurality of horizontal sidewall sprinklers to the piping network, activating at least one of the plurality of horizontal sidewall sprinklers in an event of a fire condition sensed by at least one of the plurality of horizontal sidewall sprinklers, and delivering the fire protection fluid supplied to each of the plurality of horizontal sidewall sprinklers from the piping network, to be output by each of the at least one activated of the plurality of horizontal sidewall sprinklers to the coverage area.

In another embodiment, a fire protection sprinkler system for a storage area for one or more commodities comprising at least one of Class I to Class IV, Group A cartoned unexpanded plastic commodities, or high energy commodities, the storage area having one or more racks that each include one or more bays. The fire protection sprinkler system comprising a piping network supplied by a source of fire protection fluid provided at the storage area, and a plurality of vertical sidewall sprinklers. Each of the plurality of vertical sidewall sprinklers having a K-factor of 11.2 gpm/(psi)^{1/2} or greater and being positioned vertically at a perimeter of the one or more racks to direct the fire protection fluid into the one or more bays. Each of the plurality of vertical sidewall sprinklers including a deflector, the deflector being configured to distribute the fire protection fluid into the one or more bays to a coverage area of the storage area.

In another embodiment, a method of providing a fire protection sprinkler system for a storage area for one or more commodities comprising at least one of Class I to Class IV, Group A cartoned unexpanded plastic commodities, or high energy commodities, the storage area having one or more racks that each include one or more bays. The method comprising providing a fire protection sprinkler system that includes a piping network supplied by a source of fire protection fluid provided at the storage area, and a plurality of vertical sidewall sprinklers, each of the plurality of vertical sidewall sprinklers having a K-factor of 11.2 gpm/(psi)^{1/2} or greater and being positioned vertically at a perimeter of the one or more racks to direct the fire protection fluid into the one or more bays, each of the plurality of vertical sidewall sprinklers including a deflector, the deflector being configured to distribute the fire protection fluid into the one or more bays to a coverage area of the storage area, installing each of the plurality of vertical sidewall sprinklers at the storage area so that the deflector of each of the plurality of vertical sidewall sprinklers is positioned above the one or more commodities, the installing including connecting each of the plurality of vertical sidewall sprinklers to the piping network, activating at least one of the plurality of vertical sidewall sprinklers in an event of a fire condition sensed by at least one of the plurality of vertical sidewall sprinklers, and delivering the fire protection fluid supplied to each of the plurality of vertical sidewall sprinklers from the piping network, to be output by each of the at least one activated of the plurality of vertical sidewall sprinklers to the coverage area.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 is an isometric view of an example horizontal sidewall sprinkler, according to the present disclosure.

FIG. 2 is a rear side view of an example horizontal sidewall sprinkler, according to the present disclosure.

FIG. 3 is a front side view of an example horizontal sidewall sprinkler, according to the present disclosure.

FIG. 4 is a longitudinal cross-sectional view of the horizontal sidewall sprinkler, taken along line 4-4 FIG. 3, according to the present disclosure.

FIG. 5A is a plan view of an arrangement of stored commodities with a fire protection sprinkler system, according to the present disclosure.

FIG. 5B is a plan view of an arrangement of stored commodities with the fire protection sprinkler system, according to another embodiment.

FIG. 6 is an end view of the arrangement of stored commodities shown in FIG. 5A, according to the present disclosure.

FIG. 7A is a plan view of an arrangement of stored commodities with a fire protection sprinkler system, according to another embodiment.

FIG. 7B is a plan view of an arrangement of stored commodities with the fire protection sprinkler system, according to another embodiment.

FIG. 8 is an end view of the arrangement of stored commodities with the fire protection sprinkler system shown in FIG. 7A, according to the present disclosure.

FIG. 9 is a side view of an example vertical sidewall sprinkler, according to the present disclosure.

FIG. 10 is a front side view of the vertical sidewall sprinkler of FIG. 9, according to the present disclosure.

FIG. 11A is a top view of an example deflector isolated from the vertical sidewall sprinkler of FIGS. 9 and 10, according to the present disclosure.

FIG. 11B is a cross-sectional side view of the deflector of FIG. 11A, taken along line 11B-11B in FIG. 11A, according to the present disclosure.

FIG. 11C is a plan view normal to a first angled portion of the deflector of FIG. 11A, according to the present disclosure.

FIG. 11D is a side view of the deflector of FIG. 11A, according to the present disclosure.

FIG. 11E is a cross-sectional front view of the deflector of FIG. 11D, taken along line 11E-11E in FIG. 11D, according to the present disclosure.

FIG. 11F is a cross-sectional rear view of the deflector of FIG. 11C, taken along line 11F-11F in FIG. 11C, according to the present disclosure.

FIG. 12A is a plan view of an arrangement of stored commodities with a fire protection sprinkler system, according to another embodiment.

FIG. 12B is a plan view of an arrangement of stored commodities with the fire protection sprinkler system, according to another embodiment.

FIG. 13 is an end view of the arrangement of stored commodities shown in FIG. 12A, according to the present disclosure.

FIG. 14A is a plan view of an arrangement of stored commodities with a fire protection sprinkler system, according to another embodiment.

FIG. 14B is a plan view of an arrangement of stored commodities with the fire protection sprinkler system, according to another embodiment.

FIG. 15 is an end view of the arrangement of stored commodities with the fire protection sprinkler system shown in FIG. 14A, according to the present disclosure.

FIG. 16A is a top view of an example deflector for a vertical sidewall sprinkler, according to another embodiment.

FIG. 16B is a cross-sectional side view of the deflector of FIG. 16A, taken along line 16B-16B in FIG. 16A, according to the present disclosure.

### DETAILED DESCRIPTION

Additional features, advantages, and embodiments of the present disclosure are set forth or apparent from a consideration of the following detailed description, drawings, and claims. Moreover, both the foregoing summary of the present disclosure and the following detailed description are exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the spirit and the scope of the present disclosure.

As used herein, the terms “first,” “second,” and “third” may be used interchangeably to distinguish one component from another and are not intended to signify location or importance of the individual components.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

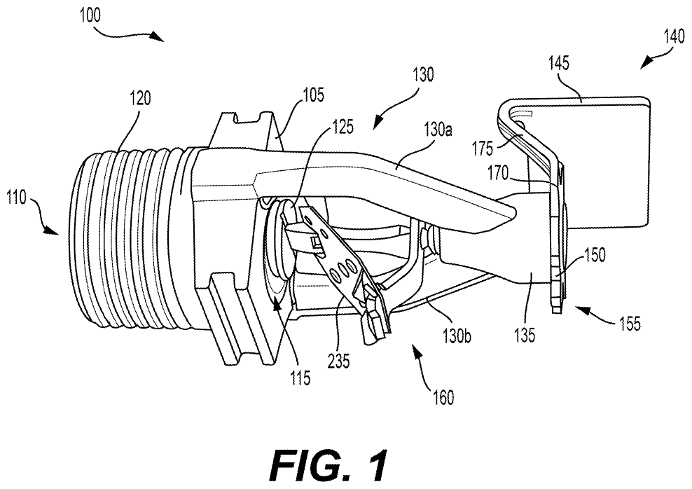

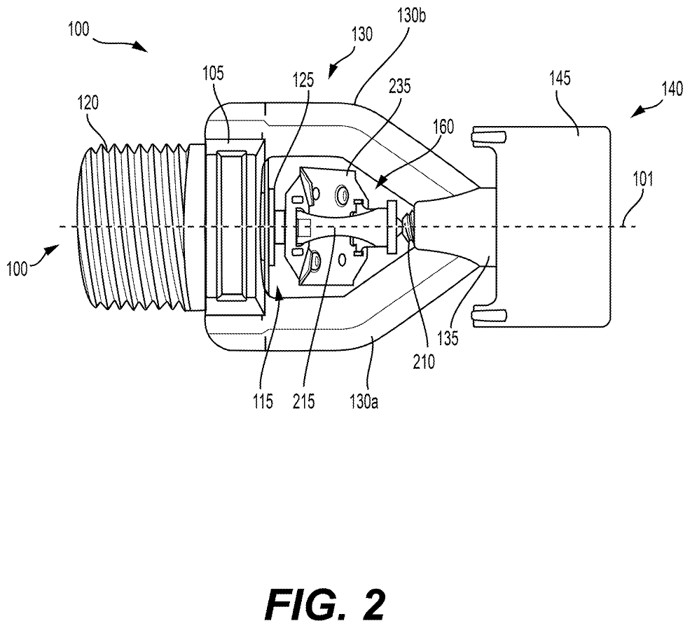

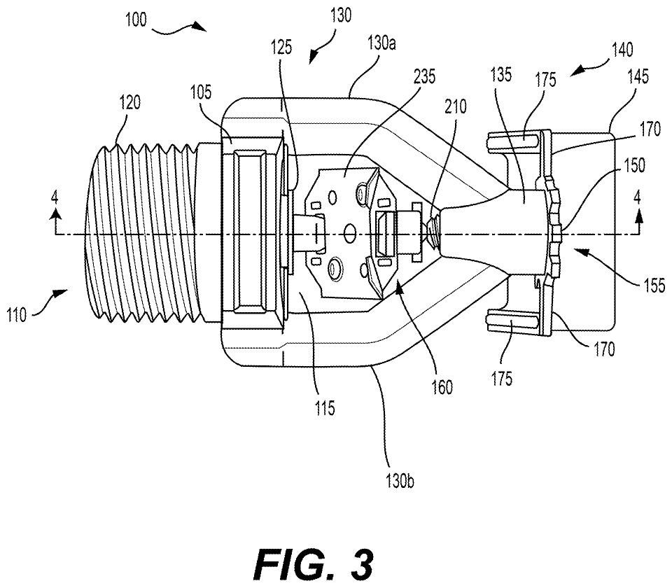

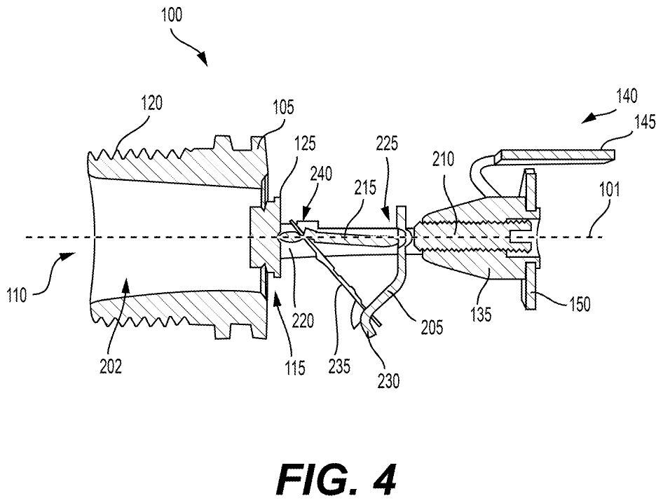

Referring now to the drawings, FIG. 1 is an isometric view of an exemplary horizontal sidewall sprinkler 100, according to the present disclosure. FIG. 2 is a rear side view of the horizontal sidewall sprinkler 100, according to the present disclosure. FIG. 3 is a front side view of the horizontal sidewall sprinkler 100, according to the present disclosure. With reference to FIGS. 1 to 3, the horizontal sidewall sprinkler 100 is a fast response fire protection sprinkler that has a sprinkler axis 101 and includes a body 105 defining an axial fluid flow passage 202 (FIG. 4) having an inlet orifice 110 and an outlet orifice 115. The top of the body 105 has a threaded portion 120 on an outer surface to allow the horizontal sidewall sprinkler 100 to be connected to a conduit (not shown in FIG. 1) for providing a pressurized fire-extinguishing fluid, such as water, to an input end near the inlet orifice 110 of the fluid passage, as detailed further below. The outlet orifice 115 is provided at an opposite end of the fluid passage relative to the inlet orifice 110, also referred to as an output end, and is sealed by a seal cap 125. The inlet orifice 110 may have a nominal diameter of, for example, ⅝-inch (16 mm). The horizontal sidewall sprinkler 100 has a K-factor of, for example, 11.2 gpm/(psi)^{1/2} (160 L/min/bar^{1/2}), that, as mentioned above, is defined by K=Q/P^{1/2}, where Q is the flow rate in gallons per minute, and P is the residual pressure at the inlet of the sprinkler in pounds per square inch. The K-factor of the horizontal sidewall sprinkler 100 can be greater than 11.2 gpm/(psi)^{1/2} (160 L/min/bar^{1/2}) with a K-factor up to 25.2 gpm/(psi)^{1/2} (360 L/min/bar^{1/2}) or 33.6 gpm/(psi)^{1/2} (480 L/min/bar^{1/2}) being applicable to protecting higher energy contents. For example, the K-factor can be 11.2 gpm/(psi)^{1/2} (160 L/min/bar^{1/2}), 14.0 gpm/(psi)^{1/2} (200 L/min/bar^{1/2}), 16.8 gpm/(psi)^{1/2} (240 L/min/bar^{1/2}), 22.4 gpm/(psi)^{1/2} (320 L/min/bar^{1/2}), 25.2 gpm/(psi)^{1/2} (360 L/min/bar^{1/2}), 28.0 gpm/(psi)^{1/2} (400 L/min/bar^{1/2}), or 33.6 gpm/(psi)^{1/2} (480 L/min/bar^{1/2}). The flow rate of the horizontal sidewall sprinkler is sixty gallons per minute (60 GPM), but may be as low as thirty gallons per minute (30 GPM) when protecting contents with less stored energy and as high as one hundred twenty gallons per minute (120 GPM) when protecting contents with more stored energy.

Two frame arms 130 extend from a lower portion of the body 105, and meet at a hub 135 that is positioned downstream and is in axial alignment with the outlet orifice 115. The two frame arms 130 include a first frame arm 130a and a second frame arm 130b (shown in FIGS. 2 and 3). The first frame arm 130a and the second frame arm 130b extend from opposite sides of the output end of the body 105 and meet at the hub 135. The two frame arms 130 form a plane. A deflector 140 is positioned and mounted on the hub 135 so as to be impinged by the fluid that passes through the fluid passage upon activation of the horizontal sidewall sprinkler 100. The deflector 140 has a horizontal shelf 145 and a vertical face 150 that is approximately perpendicular to the horizontal shelf 145. The horizontal shelf 145 is horizontal, and is parallel with the frame arms 130 (e.g., parallel with respect to the sprinkler axis 101), but the horizontal shelf 145 also may be angled slightly upward or downward to help achieve a desired spray pattern. The vertical face 150 in this particular embodiment is a circular, planar disk that is centered on and orthogonal to a fluid flow axis of the fluid passage (e.g., the sprinkler axis 101). The vertical face 150, i.e., the disk, has a plurality of slots 155 arrayed around a periphery of the vertical face 150. The plurality of slots 155 disperse the fluid to help achieve a desired spray pattern. A release mechanism, e.g., a fusible link assembly 160, having a thermally responsive element 235, e.g., a fusible link, is positioned between the hub 135 and the seal cap 125 to hold the seal cap 125 in place over the outlet orifice 115.

Two first arm portions 170 (FIGS. 1 and 3) of the deflector 140 extend from the sides of the vertical face 150. The first arm portions 170 extend in the plane of the vertical face 150 and then, as shown in the view of FIGS. 1 and 3, bend approximately 350 to form two backwardly extending (i.e., toward the base of the sprinkler) second arm portions 175 that extend to the horizontal shelf 145. The second arm portions 175 then bend to form part of the back edge of the horizontal shelf 145. The horizontal shelf 145 forms an angle of about 90° with respect to the vertical face 150 and about 450 with respect to the second arm portions 175. In some embodiments, the horizontal shelf 145 is angled downward at about 20° to direct the fluid downward.

FIG. 4 is a longitudinal cross-sectional view of the horizontal sidewall sprinkler 100, taken along line 4-4 FIG. 3, according to the present disclosure. As shown in the sectional view of FIG. 2, the fusible link assembly 160 includes a lever 205 positioned on a set screw 210 that extends upward from the hub 135. A strut 215 is positioned between the seal cap 125 and the lever 205, such that one end of the strut 215 is positioned in a slot 220 on the surface of the seal cap 125 and the other end of the strut 215 is positioned in a slot 225 on the lever 205, slightly offset from an axis (e.g., the sprinkler axis 101) of the set screw 210.

The pressure of the fluid on the seal cap 125 causes a downward force to act on the strut 215, which, in turn, causes an extended end 230 of the lever 205 to tend to rotate away from the strut 215 (e.g., the lever 205 rotates counter-clockwise in the view of FIG. 4). The rotational force on the lever 205 creates a tension force on the thermally responsive element 235 that is attached to the extended end 230 of the lever 205 and to a hook 240 provided on an upper portion of the strut 215.

The thermally responsive element 235 comprises two thin, metal plates, e.g., nickel alloy, one connected to the lever 205 and the other connected to the strut 215. The plates are joined in an overlapping manner with solder that melts at a predetermined temperature. The thermally responsive element 235 separates at the predetermined temperature, due to the tension force applied by the lever 205 and the strut 215, allowing the lever 205 and the strut 215 to swing outward. This in turn releases the seal cap 125 and allows the fluid to be output from the outlet orifice 115. Of course, other types of release mechanisms may be used, including, but not limited to, for example, a frangible bulb or a sensor, strut, and lever assembly. The vertical face 150 and the horizontal shelf 145 of the deflector 140 directs the fluid in a desired spray pattern.

FIG. 4 also shows that the majority of the length of the horizontal shelf 145 (as measured in the generally horizontal direction of fluid output) is forwardly positioned with respect to the vertical face 150 of the deflector 140. In other words, the portion of the horizontal shelf 145 extending in front of the vertical face 150 of the deflector 140 is greater than about 50% of the total length of the horizontal shelf 145. Other proportions also are possible. For example, the forwardly-extended portion of the horizontal shelf 145 may extend less than 50% in front of the vertical face 150. Such a shorter horizontal shelf 145 results in less bending stress and greater stability for the deflector 140, while maintaining the required spray pattern, as compared to longer horizontal shelves. A shorter shelf also results a shorter overall length for the horizontal sidewall sprinkler 100, which helps reduce the risk of damage to installed units and improves the aesthetic characteristics of the sprinkler.

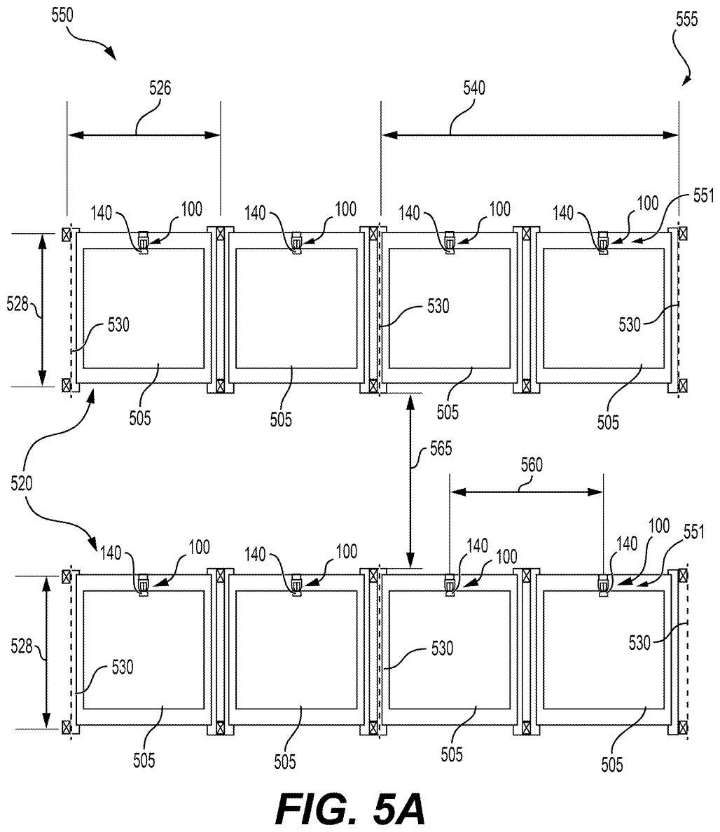

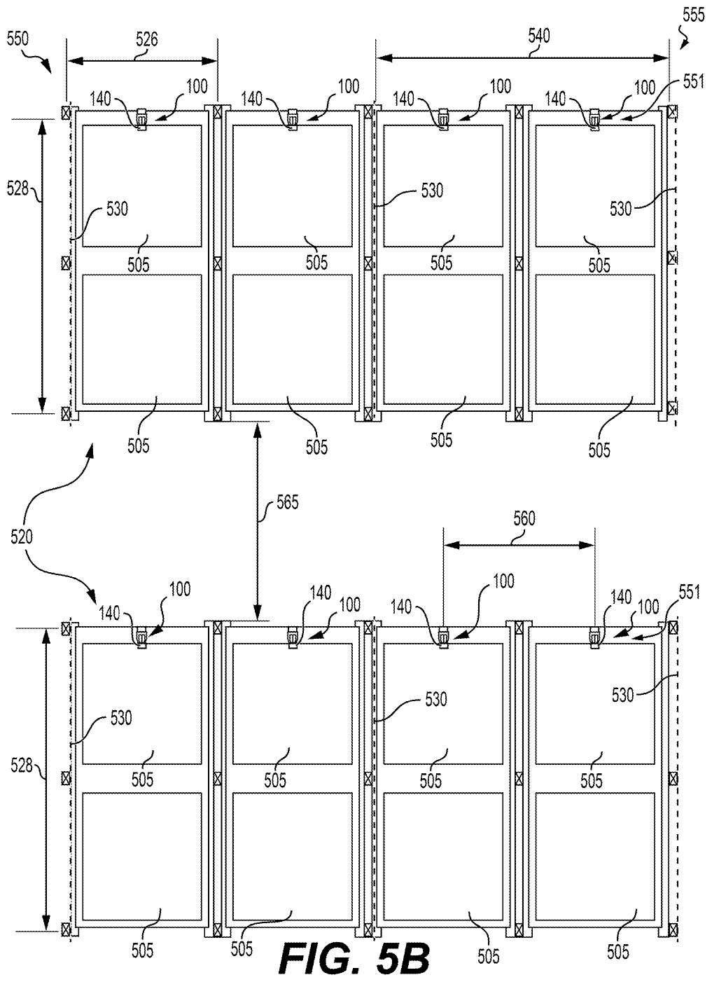

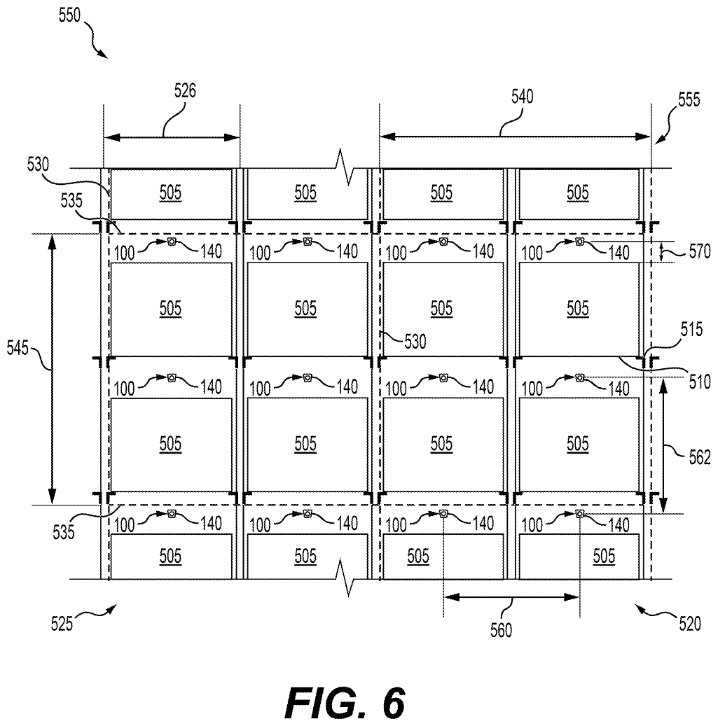

FIG. 5A is a plan view of an arrangement of stored commodities 505, according to the present disclosure. FIG. 5B is a plan view of an arrangement of the stored commodities 505, according to another embodiment. FIG. 5A shows a single row rack configuration in which there is only a single row of commodities within a respective rack, and FIG. 5B shows a double row rack configuration in which there are two rows of commodities within a respective rack. FIG. 6 is an elevation view of the arrangement of stored commodities 505 shown in FIG. 5A, according to the present disclosure. Rack storage is a conventional storage arrangement used in various industries and facilities, as detailed above. Typically, a commodity 505 to be protected is placed on a pallet 510 and the commodity 505 and the pallet 510 are stored together on a shelf 515 in a rack 520, as shown in FIGS. 5A and 5B.

Racks can be single row (FIG. 5A), double row (FIG. 5B), or multiple row, with or without solid shelving. The terms “single row,” “double row,” and “multiple row” refer to the depth of the rack configuration in terms of the number of pallets that can be stored back-to-back. Each rack 520 can include one or more bays 525 that define columns of the rack 520. The one or more bays 525 include a bay width 526 of three feet (3 ft.), but may range from eighteen inches (18 inches) to eight feet (8 ft.). The racks 520 include a storage depth 528 of three feet (3 ft.), but may range from eighteen inches to eight feet (8 ft.). Each rack 520 also includes one or more vertical barriers 530 and one or more horizontal barriers 535.

The one or more vertical barriers 530 and the one or more horizontal barriers 535 help to capture heat from a fire within the rack 520 to help cause the operation of the horizontal sidewall sprinklers 100, as well as limiting the spread of the fire across the one or more vertical barriers 530 and the one or more horizontal barriers 535. For example, the barriers 530, 535 are made of plywood or particleboard, sheet metal, or the like. The one or more vertical barriers 530 extend vertically along the rack 520 from a maximum of four inches (4 in.) above the floor to the maximum storage height. The one or more horizontal barriers 535 extend from aisle to aisle horizontally along the rack 520. The one or more vertical barriers 530 are spaced horizontally (e.g., in the orientation shown in FIGS. 5A, 5B, and 6) from each other at a vertical barrier spacing 540 of six feet (6 ft.), but may range from eighteen inches (18 in.) to ten feet (10 ft.). The one or more horizontal barriers 535 are spaced vertically (e.g., in the orientation shown in FIGS. 5A, 5B, and 6) from each other at a horizontal barrier spacing 545 of six feet (6 ft.), but may range from two feet (2 ft.) to ten feet (10 ft.).

With reference to FIGS. 5A, 5B, and 6, a fire protection sprinkler system 550 includes the horizontal sidewall sprinklers 100 placed within a room, also referred to as a storage area 555, with a floor and a ceiling. The storage area 555 includes one or more racks 520 for storing one or more commodities 505. The fire protection sprinkler system 550 includes a plurality of horizontal sidewall sprinklers 100 connected to a piping network 551 including one or more pipes. The piping network 551 is located outside of the one or more racks 520. In this way, the one or more pipes of the piping network 551 are located outside of the one or more racks 520 and do not extend through, or within, the one or more racks 520. The horizontal sidewall sprinklers 100 are spaced laterally (e.g., horizontally) from each other at a lateral sprinkler spacing 560 in a range from eighteen inches (18 inches) to ten feet (10 ft.), the horizontal spacing varying depending on the fire hazard of the content being protected. The lateral spacing is needed to allow the adequate water to be discharged from the horizontal sidewall sprinklers 100 onto burning contents to allow the fire to be controlled or suppressed. The horizontal sidewall sprinklers 100 are spaced vertically from each other at a vertical sprinkler spacing 562 in a range from two feet (2 ft.) to ten feet (10 ft.). The vertical spacing of the horizontal sidewall sprinklers 100 is needed to provide for timely operation of the horizontal sidewall sprinklers 100 during a fire condition as well as to allow adequate water discharged by the sprinkler upon operation to reach the burning contents below, with the ability of the water to travel downwards through the fire reduced as the energy released by the fire increases. The horizontal sidewall sprinklers 100 are positioned such that the deflector 140 of each horizontal sidewall sprinkler 100 is configured to direct the fluid towards the commodities 505 within the racks 520. For example, each horizontal sidewall sprinkler 100 is installed at a perimeter of the racks 520 and are configured to spray the fluid into the racks 520. The horizontal sidewall sprinklers 100 are positioned to extend into the racks 520 from the perimeter such that the horizontal sidewall sprinklers 100 are positioned above the commodities 505 of a respective bay 525. For example, the deflector 140 of each horizontal sidewall sprinkler 100 is positioned above the commodities 505. When the racks 520 are double row racks as shown in FIG. 5B, the horizontal sidewall sprinklers 100 can be positioned above a single row of the commodities 505, or can be positioned above each row (e.g., both rows or all rows) of the commodities. In this way, the horizontal sidewall sprinklers 100 are referred to as in-rack sprinklers. Such a configuration helps to simplify the piping installation by avoiding piping within the footprint of the rack structure as compared to in-rack sprinkler systems that utilize pendent sprinklers or upright sprinklers. The fire protection sprinkler system 550 reduces the amount of fluid reaching the burning combustibles within the racks 520 as compared to horizontal sidewall sprinklers without the benefit of the present disclosure. For example, the K-factor of 11.2 gpm/(psi)^{1/2} or greater allows for the reduction in the amount of fluid, with a shorter water spray distance as compared to horizontal sidewall sprinklers without the benefit of the present disclosure.

The racks 520 are spaced by aisles having an aisle width 565 of four feet (4 ft.), but the aisle width 565 may be as small as three feet (3 ft.) or three and a half feet (3.5 ft.). The racks 520 include a deflector-to-commodity clearance 570 from the top of the commodities 505 to the deflector 140 of each horizontal sidewall sprinkler 100 of at least three inches (3 in.). The activation temperature of the horizontal sidewall sprinkler 100 is two hundred twelve degrees Fahrenheit (212° F.) but may be as low as one hundred fifty-five degrees Fahrenheit (155° F.) and as high as three hundred sixty degrees Fahrenheit (360° F.) depending on the ambient temperature in the space being protected. The discharge pressure of the fluid from the horizontal sidewall sprinkler 100 is nominally twenty-nine pounds per square inch (29 psi), buy may be as low as seven pounds per square inch (7 psi) for lower water flow rates and as high as one hundred fifteen pounds per square inch (115 psi) for higher water flow rates.

In operation, at least one of the plurality of horizontal sidewall sprinklers 100 is activated in the event of a fire condition sensed by the thermally responsive element 235 (FIGS. 1 to 4). The fire protection fluid is delivered from the piping network 551 and output by each of the at least one activated of the plurality of horizontal sidewall sprinklers 100 to a coverage area. The coverage area is at least the size (e.g., width and depth) of the one or more bays 525. In this way, each horizontal sidewall sprinkler 100 installed at one face of the rack 520 (e.g., at the perimeter) provides coverage across the full depth of the rack 520. For example, each horizontal sidewall sprinkler 100 provides coverage across an entirety of the bay width 526 and an entirety of the storage depth 528. The horizontal sidewall sprinklers 100 output the fire protection fluid horizontally and a portion of the fire protection fluid impinges on the deflector 140. The deflector 140 directs the fire protection fluid generally horizontally into the rack 520 and towards the commodities 505. In particular, the fire protection fluid impinges on the vertical face 150 and the vertical face 150 directs the fire protection fluid vertically towards the horizontal shelf 145. The fire protection fluid impinges on the horizontal shelf 145 and the horizontal shelf 145 directs the fire protection fluid into the rack 520 and towards the commodities 505. In this way, the vertical face 150 and the horizontal shelf 145 together direct the fire protection fluid to the coverage area.

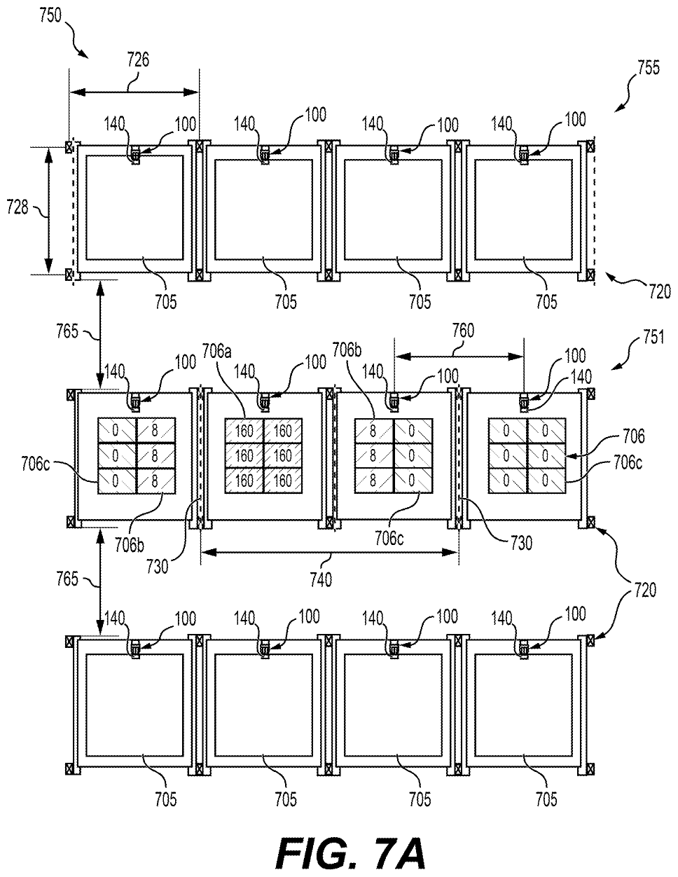

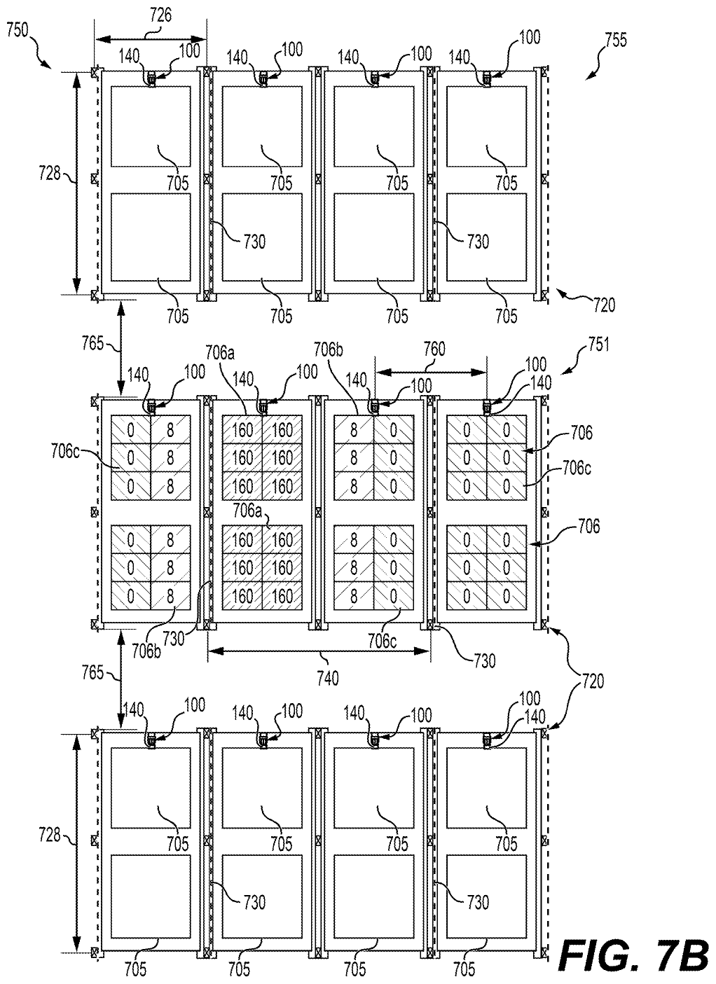

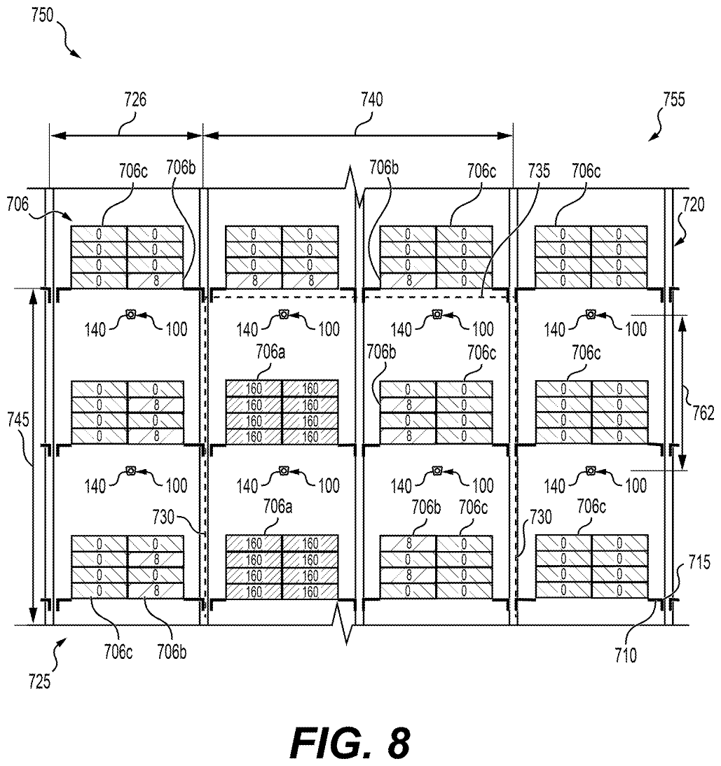

FIG. 7A is a plan view of an arrangement of stored commodities 705 and high energy commodities 706, according to the present disclosure. FIG. 7B is a plan view of an arrangement of the stored commodities 705, according to another embodiment. FIG. 7A shows a single row rack configuration in which there is only a single row of commodities within a respective rack, and FIG. 7B shows a double row rack configuration in which there are two rows of commodities within a respective rack. FIG. 8 is an elevation view of the arrangement of stored commodities 705 and high energy commodities 706 shown in FIG. 7A, according to the present disclosure. Rack storage is a conventional storage arrangement used in various industries and facilities, as detailed above. Typically, the commodity 705 and the high energy commodities 706 to be protected are placed on a pallet 710 and are stored on a shelf 715 in a rack 720, as shown in FIGS. 7A and 7B. The commodity 705 includes a cartoned unexpanded plastic (CUP) commodity, but can include any type of commodity detailed above. The high energy commodities 706 include one or more Lithium-ion battery cells, but can include any type of high energy commodity. For example, the high energy commodities 706 include one or more first trays 706a that are full of Lithium-ion battery cells (e.g., “160” cells make a full tray). The high energy commodities 706 also include one or more second trays 706b that are partially full of Lithium-ion battery cells (e.g., “8” cells in a partially full tray). The high energy commodities 706 also include one or more third trays 706c that are empty (e.g., “0” cells stored therein).

Racks can be single row (e.g., FIG. 7A), double row (e.g., FIG. 7B), or multiple row, with or without solid shelving. The terms “single row,” “double row,” and “multiple row” refer to the depth of the rack configuration in terms of the number of pallets that can be stored back-to-back. Each rack 720 can include one or more bays 725 that define columns of the rack 720. The one or more bays 725 include a bay width 726 of three feet (3 ft.), but may range from eighteen inches (18 in.) to eight feet (8 ft.). The racks 720 include a storage depth 728 of three feet (3 ft.), but may range from eighteen inches (18 in.) to eight feet (8 ft.).

Each rack 720 also includes one or more vertical barriers 730 and one or more horizontal barriers 735. The one or more vertical barriers 730 extend vertically along the rack 720 from a maximum of four inches (4 in.) above the floor to the maximum storage height. The one or more horizontal barriers 735 extend horizontally along the rack 720 across two adjacent bays 725. The one or more vertical barriers 730 are spaced horizontally (e.g., in the orientation shown in FIGS. 7A, 7B, and 8) from each other at a vertical barrier spacing 740 of six feet (6 ft, but may range from eighteen inches (18 inches) to ten feet (10 ft.). The one or more horizontal barriers 735 are spaced vertically (e.g., in the orientation shown in FIGS. 7A, 7B, and 8) from each other at a horizontal barrier spacing 745 of six feet (6 ft, but may range from two feet (2 ft.) to ten feet (10 ft.).

With reference to FIGS. 7A, 7B, and 8, a fire protection sprinkler system 750 includes the horizontal sidewall sprinklers 100 placed within a room, also referred to as a storage area 755, with a floor and a ceiling. The storage area 755 includes one or more racks 520 for storing one or more commodities 705 and/or one or more high energy commodities 706. The fire protection sprinkler system 750 includes a plurality of horizontal sidewall sprinklers 100 connected to a piping network 751 including one or more pipes. The piping network 751 is located outside of the one or more racks 720. In this way, the one or more pipes of the piping network 751 are located outside of the one or more racks 720 and do not extend through, or within, the one or more racks 720. The horizontal sidewall sprinklers 100 are spaced laterally (e.g., horizontally) from each other at a lateral sprinkler spacing 760 in a range from eighteen inches (18 inches) to ten feet (10 ft.), the horizontal spacing varying depending on the fire hazard of the content being protected. The lateral spacing is needed to allow the adequate water to be discharged from the horizontal sidewall sprinklers 100 onto burning contents to allow the fire to be controlled or suppressed. The horizontal sidewall sprinklers 100 are spaced vertically from each other at a vertical sprinkler spacing 762 in a range from two feet (2 ft.) to ten feet (10 ft.). The vertical spacing of the horizontal sidewall sprinklers 100 is needed to provide for timely operation of the horizontal sidewall sprinklers 100 during a fire condition as well as to allow adequate water discharged by the sprinkler upon operation to reach the burning contents below, with the ability of the water to travel downwards through the fire reduced as the energy released by the fire increases. The horizontal sidewall sprinklers 100 are positioned such that the deflector 140 of each horizontal sidewall sprinkler 100 is configured to direct the fluid towards the high energy commodities 706 within the rack 720. For example, each horizontal sidewall sprinkler 100 is installed at a perimeter of the rack 720 and are configured to spray the fluid into the racks 720. The horizontal sidewall sprinklers 100 are positioned to extend into the racks 720 from the perimeter such that the horizontal sidewall sprinklers 100 are positioned above the commodities 705 or the high energy commodities 706 of a respective bay 725. For example, the deflector 140 of each horizontal sidewall sprinkler 100 is positioned above the commodities 705 and the high energy commodities 706. When the racks 720 are double row racks as shown in FIG. 7B, the horizontal sidewall sprinklers 100 can be positioned above a single row of the commodities 705 or the high energy commodities 706, or can be positioned above each row (e.g., both rows or all rows) of the commodities or the high energy commodities 706. In this way, the horizontal sidewall sprinklers 100 are referred to as in-rack sprinklers. Such a configuration helps to simplify the piping installation by avoiding piping within the footprint of the rack structure as compared to in-rack sprinkler systems that utilize pendent sprinklers or upright sprinklers. To further direct water discharging from the horizontal sidewall sprinklers 100 within the rack structure, the horizontal sidewall sprinklers may be installed at an angle between horizontal and forty-five degrees (45°) below horizontal. The fire protection sprinkler system 750 reduces the amount of fluid reaching the burning combustibles within the racks 720 as compared to horizontal sidewall sprinklers without the benefit of the present disclosure.

The racks 720 are spaced by aisles having an aisle width 765 of four feet (4 ft.), but the aisle width may be as small as three feet (3 ft.) or three and a half feet (3.5 ft.). The racks 720 include a deflector-to-commodity clearance (e.g., the deflector-to-commodity clearance 570) from the top of the high energy commodities 706 to the deflector 140 of each horizontal sidewall sprinkler 100 of at least three inches (3 in.). The activation temperature of the horizontal sidewall sprinkler 100 ranges from one hundred fifty-five degrees Fahrenheit (155° F.) to three hundred sixty degrees Fahrenheit (360° F.) and is preferably two hundred twelve degrees Fahrenheit (212° F.). The discharge pressure of the fluid from the horizontal sidewall sprinkler 100 ranges from seven pounds per square inch (7 psi) to one hundred fifteen pounds per square inch (115 psi).

In operation, at least one of the plurality of horizontal sidewall sprinklers 100 is activated in the event of a fire condition sensed by the thermally responsive element 235 (FIGS. 1 to 4). The fire protection fluid is delivered from the piping network 751 and output by each of the at least one activated of the plurality of horizontal sidewall sprinklers 100 to a coverage area. The coverage area is at least the size (e.g., width and depth) of the one or more bays 725. In this way, each horizontal sidewall sprinkler 100 installed at one face of the rack 720 (e.g., at the perimeter) provides coverage across the full depth of the rack 720. For example, each horizontal sidewall sprinkler 100 provides coverage across an entirety of the bay width 726 and an entirety of the storage depth 728.

Test results for a Lithium-ion battery test are provided herein. The cell configuration included cylindrical 18650 Lithium-ion battery cells. The cell quantity was 8,000 Lithium-ion battery cells. The cell cathode chemistry included nickel cobalt aluminum (NCA). The cell state of charge (SOC) was 100%. The storage configuration included non-reinforced polypropylene formation trays that included one hundred sixty (160) cells per tray. In the test, two horizontal sidewall sprinklers 100 were activated within the barrier area (e.g., within the area defined by the vertical barriers 730 and the horizontal barriers 735) following the initiation of thermal runaway cell-to-cell propagation. The cell-to-cell thermal runaway propagation was arrested. There was no damage to the target trays or to the target racks.

Accordingly, the horizontal sidewall sprinkler 100 of the present disclosure allows for in-rack sprinklers to be installed where the piping supplying the in-rack sprinklers is located outside of the rack structure. Locating the piping supply the in-rack sprinklers outside of the rack simplifies the installation of the piping and allows for more contents (e.g., stored commodities) to be located within a given volume of rack. The horizontal sidewall sprinkler 100 limits the distance that must be maintained between the sprinkler and the contents stored below, with the horizontal installation of the sprinkler further reducing the space needed for installation of the sprinkler within the rack compared with pendent sprinklers and upright sprinklers. Further, the horizontal sidewall sprinkler 100 of the present disclosure allows the majority of the water, upon operation of the sprinkler, to be directed towards the contents in the racks and limits the amount of water reaching the aisle adjacent to the rack.

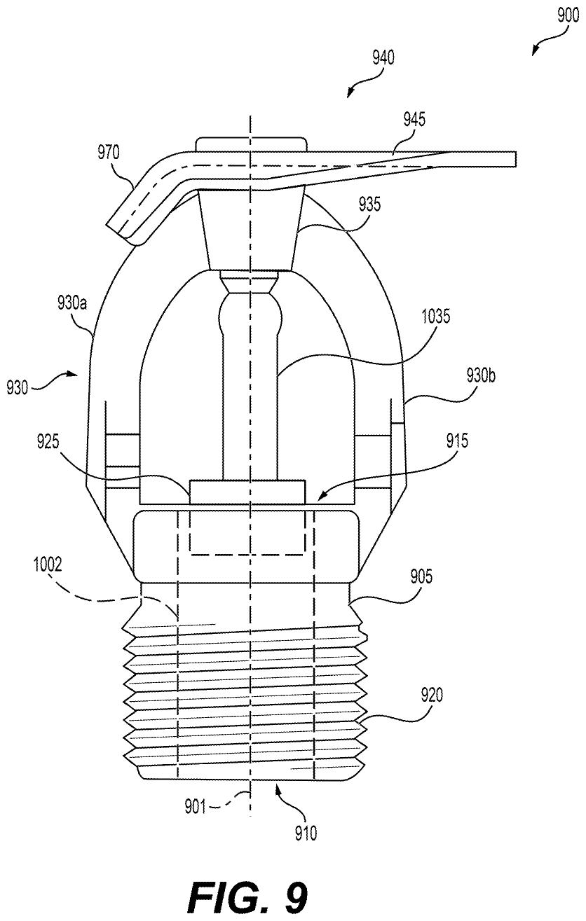

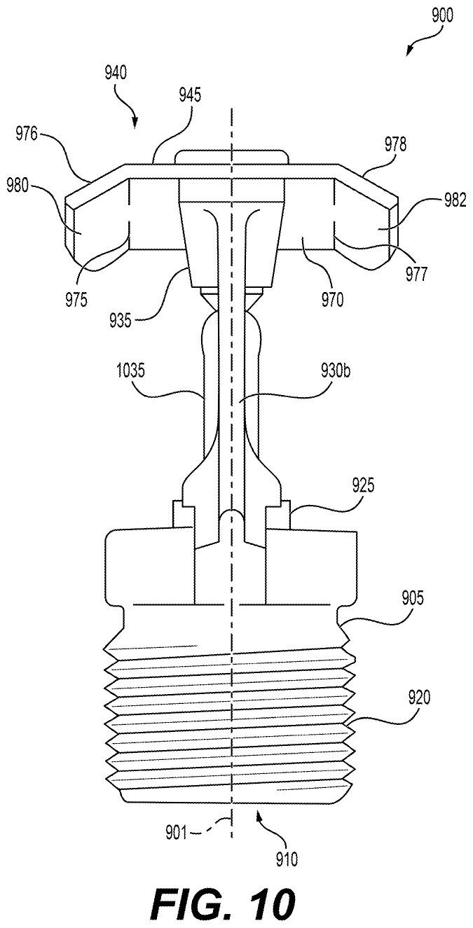

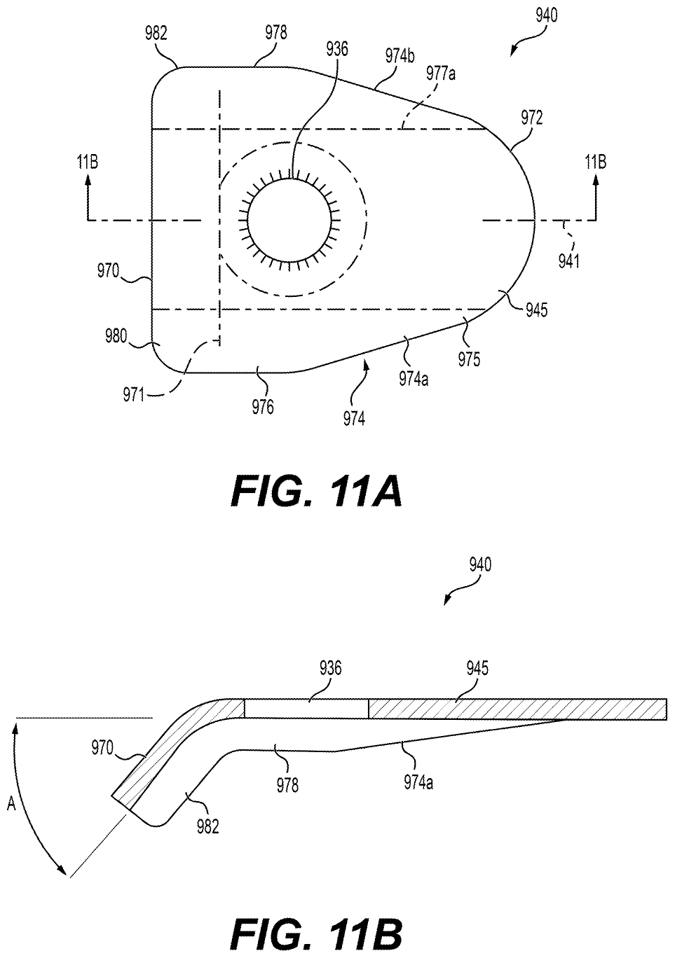

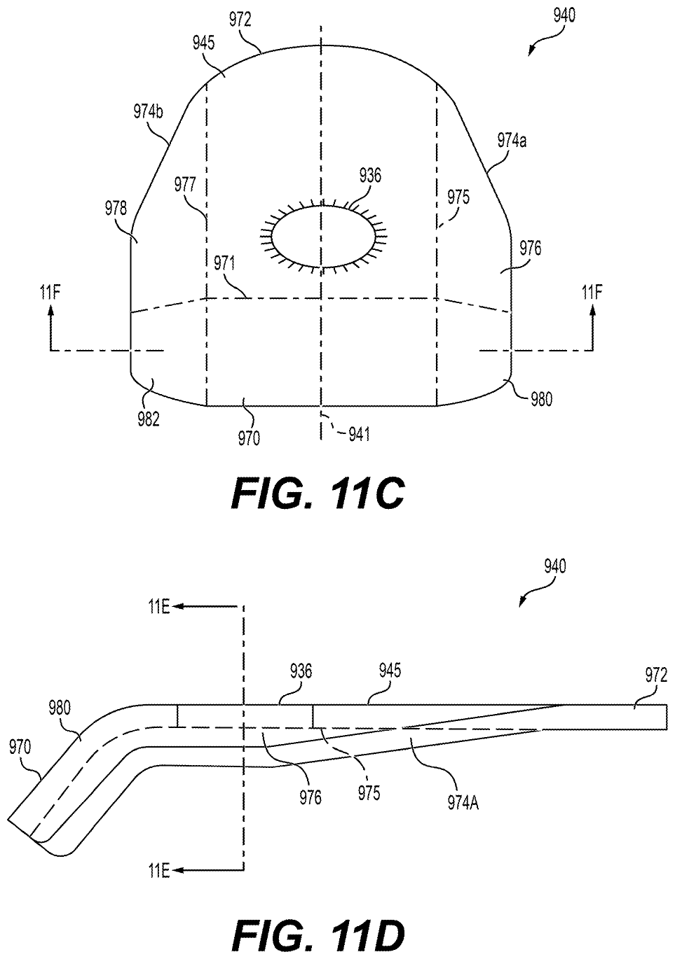

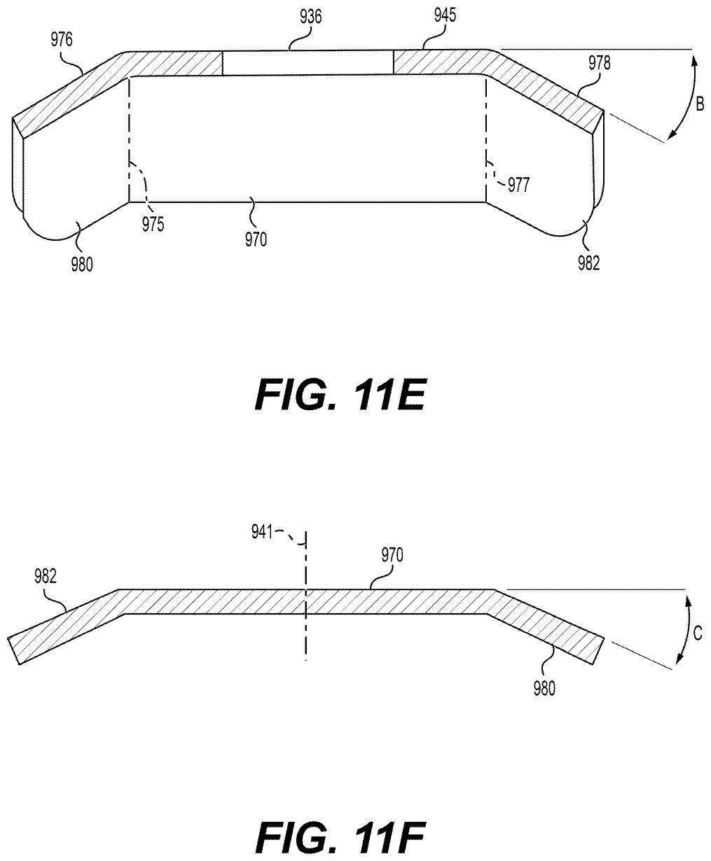

FIG. 9 is a side view of an example vertical sidewall sprinkler 900, according to the present disclosure. FIG. 10 is a front side view of the vertical sidewall sprinkler 900, according to the present disclosure. FIG. 11A is a top view of an example deflector 940 isolated from the vertical sidewall sprinkler 900, according to the present disclosure. FIG. 11B is a cross-sectional side view of the deflector 940, taken along line 11B-11B in FIG. 11A, according to the present disclosure. FIG. 11C is a plan view normal to a first angled portion 970 of the deflector 940, according to the present disclosure. FIG. 11D is a side view of the deflector of 940, according to the present disclosure. FIG. 11E is a cross-sectional front view of the deflector 940, taken along line 11E-11E in FIG. 11D, according to the present disclosure. FIG. 11F is a cross-sectional rear view of the deflector 940, taken along line 11F-11F in FIG. 11C, according to the present disclosure.

With reference to FIGS. 9 to 11F, the vertical sidewall sprinkler 900 is a fast response fire protection sprinkler and has a sprinkler axis 901. The vertical sidewall sprinkler 900 includes a body 905 that extends along the sprinkler axis 901 and defining an axial fluid flow passage 1002 having an inlet orifice 910 and an outlet orifice 915. The body 905 has a threaded portion 920 on an outer surface to allow the vertical sidewall sprinkler 900 to be connected to a conduit (not shown in FIG. 9) for providing a pressurized fire-extinguishing fluid, such as water, to an input end near the inlet orifice 910 of the fluid passage, as detailed further below. When the vertical outlet orifice 915 is provided at an opposite end of the fluid passage relative to the inlet orifice 910, also referred to as an output end, and is sealed by a seal cap 925. The inlet orifice 910 may have a nominal diameter of, for example, ⅝-inch (16 mm). The vertical sidewall sprinkler 900 has a K-factor of, for example, 11.2 gpm/(psi)^{1/2} (160 L/min/bar^{1/2}). The K-factor of the vertical sidewall sprinkler 900 can be greater than 11.2 gpm/(psi)^{1/2} (160 L/min/bar^{1/2}) with a K-factor up to 33.6 gpm/(psi)^{1/2} being applicable to protecting higher energy contents. For example, the K-factor can be 11.2 gpm/(psi)^{1/2} (160 L/min/bar^{1/2}), 14.0 gpm/(psi)^{1/2}(200 L/min/bar^{1/2}), 16.8 gpm/(psi)^{1/2}(240 L/min/bar^{1/2}), 22.4 gpm/(psi)^{1/2} (320 L/min/bar^{1/2}), 25.2 gpm/(psi)^{1/2} (360 L/min/bar^{1/2}), 28.0 gpm/(psi)^{1/2} (400 L/min/bar^{1/2}), or 33.6 gpm/(psi)^{1/2}(480 L/min/bar^{1/2}). The flow rate of the vertical sidewall sprinkler 900 is sixty gallons per minute (60 GPM), but may be as low as thirty gallons per minute (30 GPM) when protecting contents with less stored energy and as high as one hundred twenty gallons per minute (120 GPM) when protecting contents with more stored energy.

Two frame arms 930 extend from a upper portion of the body 905, and meet at a hub 935 that is positioned downstream and is in axial alignment with the outlet orifice 915. The two frame arms 930 include a first frame arm 930a and a second frame arm 930b. The first frame arm 930a and the second frame arm 930b extend from opposite sides of the output end of the body 905 and meet at the hub 935. The two frame arms 930 form a plane. A deflector 940 is positioned and mounted on the hub 935 so as to be impinged by the fluid that passes through the fluid passage upon activation of the vertical sidewall sprinkler 900. The deflector 940 has a horizontal shelf 945. The horizontal shelf 945 is horizontal, and is orthogonal to the frame arms 930, but the horizontal shelf 945 also may be angled slightly upward or downward to help achieve a desired spray pattern. A release mechanism having a thermally responsive element 1035, e.g., a glass bulb, is positioned between the hub 935 and the seal cap 925 to hold the seal cap 925 in place over the outlet orifice 915. Of course, other types of release mechanisms may be used, including, but not limited to, for example, a fusible link (e.g., similar to the fusible link assembly 160 of FIGS. 1 to 4), or a sensor, strut, and lever assembly.

The deflector 940 is arranged to direct water in a generally horizontal direction when the vertical sidewall sprinkler 900 is mounted vertically, either in a pendent configuration or an upright configuration. For this purpose, the deflector 940 includes the horizontal shelf 945, also referred to as a planar central portion, that is substantially perpendicular to the sprinkler axis 901 and extending in a direction parallel to the plane of the frame arms 930 of the body 905 on one side of the sprinkler axis 901. The deflector 940 extends along a deflector axis 941 that is perpendicular to the sprinkler axis 901.

On the opposite side of the sprinkler axis 901, the deflector 940 is bent at an angle A from the horizontal shelf 945, preferably about 50°, toward the axial fluid flow passage 1002 forming a first angled portion 970 as shown in FIGS. 11A and 11B. The first angled portion 970 is further defined by a first bend line 971. The horizontal shelf 945 of the deflector 940 has a curved end edge 972 and straight edge portions 974 (including a first straight edge portion 974a and a second straight edge portion 974b) extending away from the curved end edge 972 in the regions spaced outwardly from the plane of the frame arms 930. Those regions are further defined by a second bend line 975 and a third bend line 977 which extend parallel to the deflector axis 941 of the deflector 940 and extend to the end of the first angled portion 970. Those regions are bent toward the axial fluid flow passage 1002 and the frame arms 930 at an angle B as shown in FIG. 11E, which is about 30° or greater from the plane of the horizontal shelf 945, forming a second angled portion 976 and a third angled portion 978. The preferred angle from the horizontal forming the second angled portion 976 and the third angled portion 978 is about 32°; however, the angle can also be 350 or greater. As shown in FIG. 11F, a section 980 of the second angled portion 976 and a section 982 of the third angled portion 978 (e.g., that are also part of the first angled portion 970) are bent at an angle C, that is approximately 25°, relative to the first angled portion 970 toward the axial fluid flow passage 1002 and the frame arms 930.

In one embodiment, the deflector 940 is approximately 1.39 inches long, from the tip of the curved end edge 972 to the distal end of the first angled portion 970 along the deflector axis 941, and is 1.5 inches long prior to bending. The deflector 940 is approximately 1.165 inches wide, prior to bending, across the first angled portion 970 and approximately 0.0625 inches thick. The second bend line 975 and the third bend line 977 are approximately 0.34375 inches from the deflector axis 941. The first bend line 971 is slightly greater than approximately 1.090 inches from the tip of the curved end edge 972. The opening 936 is centered approximately 0.920 inches from the tip of the curved end edge 972 and has a radius of approximately 0.17 inches with deep radial serrations at about every 10°. The straight edge portions 974 form an included angle of approximately 32°. The curved end edge 972 has a radius of approximately 0.440 inches. In other embodiments, the deflector 940 can include other dimensions while achieving a similar result of the desired K-factor.

The horizontal shelf 945 forms an angle of about 90° with respect to the sprinkler axis 901. In some embodiments, the horizontal shelf 145 is angled downward at about 20° to direct the fluid downward. The sprinklers can be oriented either as pendent sprinklers or as upright sprinklers.

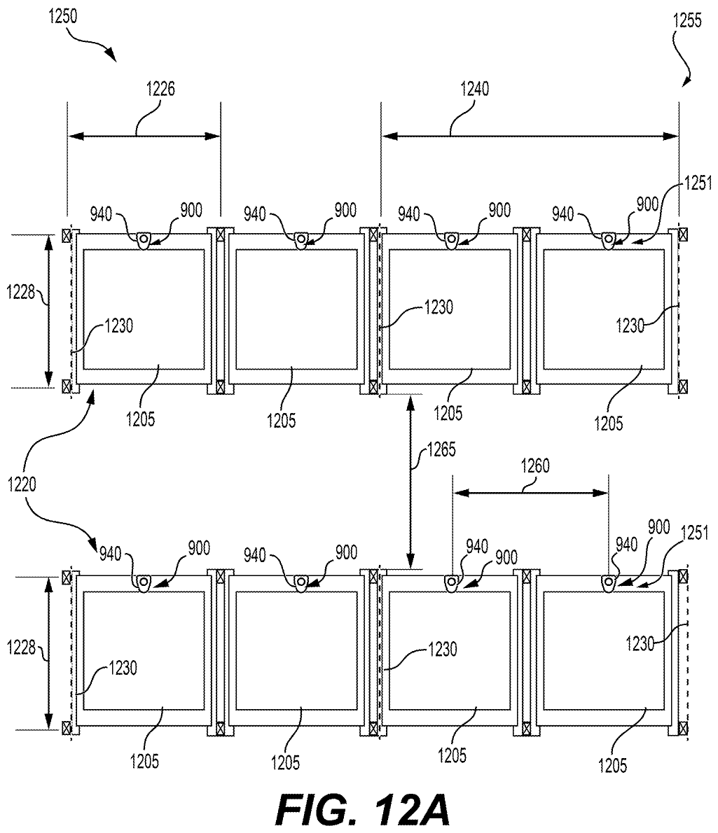

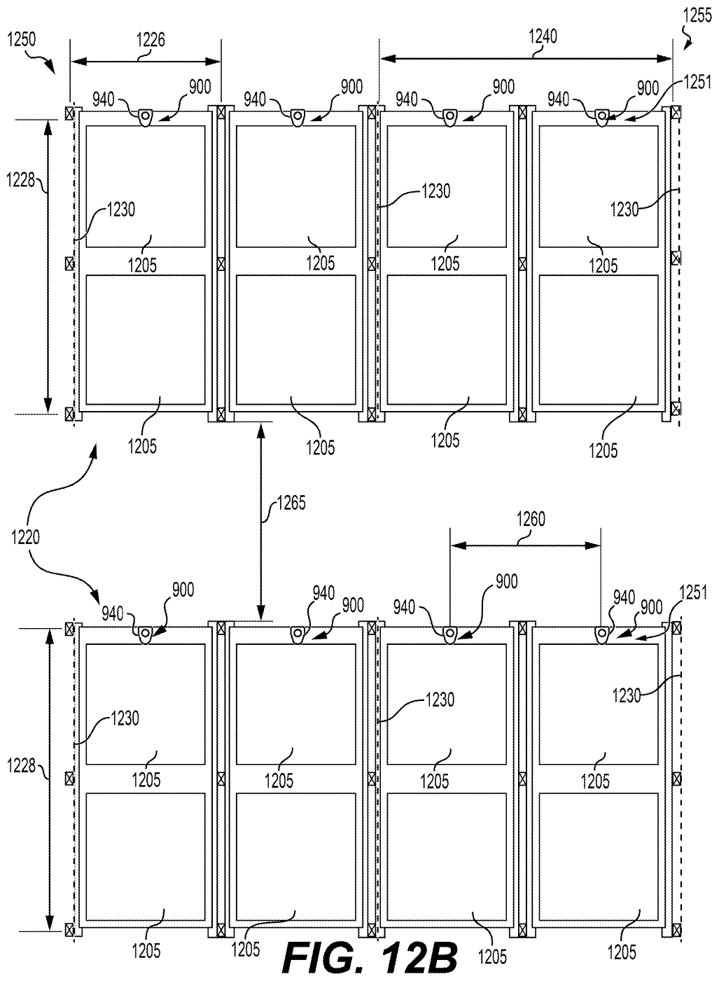

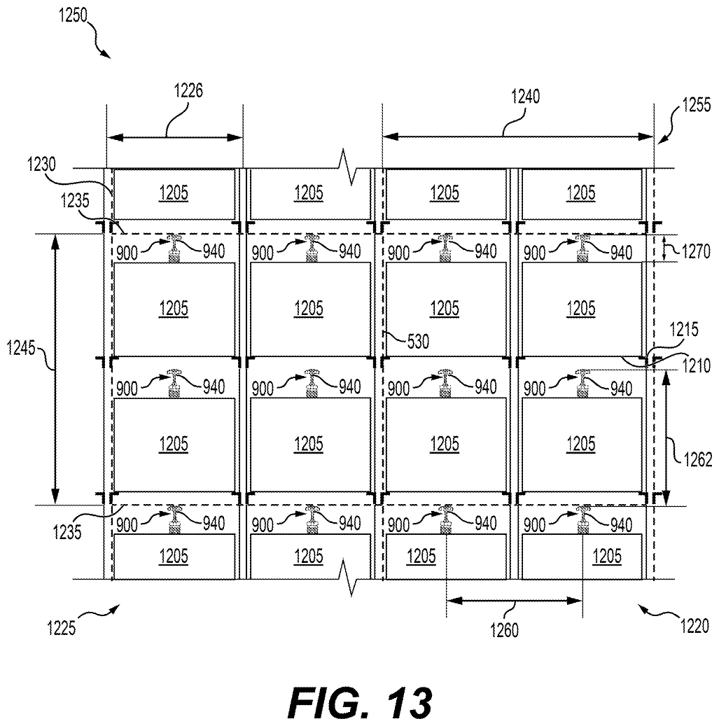

FIG. 12A is a plan view of an arrangement of stored commodities 1205 with a fire protection sprinkler system 1250, according to another embodiment. FIG. 12B is a plan view of an arrangement of the stored commodities 1205 with the fire protection sprinkler system 1250, according to another embodiment. FIG. 12A shows a single row rack configuration in which there is only a single row of commodities within a respective rack, and FIG. 12B shows a double row rack configuration in which there are two rows of commodities within a respective rack. FIG. 13 is an elevation view of the arrangement of stored commodities 1205 shown in FIG. 12A, according to the present disclosure. The arrangement of stored commodities 1205 shown in FIGS. 12A, 12B, and 13 is substantially similar to the arrangement of stored commodities 505 of FIGS. 5A, 5B, and 6, respectively. The same reference numerals will be used for components of the arrangement of stored commodities 1205 that are the same as or similar to the components of the arrangement of stored commodities 505 discussed above. The description of these components above also applies to this embodiment, and a detailed description of these components is omitted here.

The arrangement of stored commodities 1205 includes a commodity 1205 to be protected that is placed on a pallet 1210 and the commodity 1205 and the pallet 1210 are stored together on a shelf 1215 in a rack 1220, as shown in FIGS. 12A and 12B. Each rack 1220 can include one or more bays 1225 that define columns of the rack 1220. The one or more bays 1225 include a bay width 1226 of three feet (3 ft.), but may range from eighteen inches (18 inches) to eight feet (8 ft.). The racks 1220 include a storage depth 1228 of three feet (3 ft.), but may range from eighteen inches to eight feet (8 ft.). Each rack 1220 also includes one or more vertical barriers 1230 and one or more horizontal barriers 1235. The one or more vertical barriers 1230 extend vertically along the rack 1220 from a maximum of four inches (4 in.) above the floor to the maximum storage height. The one or more horizontal barriers 1235 extend from aisle to aisle horizontally along the rack 1220. The one or more vertical barriers 1230 are spaced horizontally (e.g., in the orientation shown in FIGS. 12A, 12B, and 13) from each other at a vertical barrier spacing 1240 of six feet (6 ft.), but may range from eighteen inches (18 in.) to ten feet (10 ft.). The one or more horizontal barriers 1235 are spaced vertically (e.g., in the orientation shown in FIGS. 12A, 12B, and 13) from each other at a horizontal barrier spacing 1245 of six feet (6 ft.), but may range from two feet (2 ft.) to ten feet (10 ft.).

With reference to FIGS. 12A, 12B, and 13, a fire protection sprinkler system 1250 includes the vertical sidewall sprinklers 900 placed within a room, also referred to as a storage area 1255, with a floor and a ceiling. The storage area 1255 includes one or more racks 1220 for storing one or more commodities 1205. The fire protection sprinkler system 1250 includes a plurality of vertical sidewall sprinklers 900 connected to a piping network 1251 including one or more pipes. In FIGS. 12A, 12B, and 13, the vertical sidewall sprinklers 900 are arranged in an upright configuration (e.g., extending from a top of the pipes). In some embodiments, the vertical sidewall sprinklers 900 can be arranged in a pendent configuration (e.g., extending from a bottom of the pipes). The piping network 1251 is located outside of the one or more racks 1220. The vertical sidewall sprinklers 900 are spaced laterally (e.g., horizontally) from each other at a lateral sprinkler spacing 1260 in a range from eighteen inches (18 inches) to ten feet (10 ft.), the horizontal spacing varying depending on the fire hazard of the content being protected. The lateral spacing is needed to allow the adequate water to be discharged from the vertical sidewall sprinklers 900 onto burning contents to allow the fire to be controlled or suppressed. The vertical sidewall sprinklers 900 are spaced vertically from each other at a vertical sprinkler spacing 1262 in a range from two feet (2 ft.) to ten feet (10 ft.). The vertical spacing of the vertical sidewall sprinklers 900 is needed to provide for timely operation of the vertical sidewall sprinklers 900 during a fire condition as well as to allow adequate water discharged by the sprinkler upon operation to reach the burning contents below, with the ability of the water to travel downwards through the fire reduced as the energy released by the fire increases. The vertical sidewall sprinklers 900 are positioned such that the deflector 940 of each vertical sidewall sprinkler 900 is configured to direct the fluid towards the commodities 1205 within the racks 1220. For example, each vertical sidewall sprinkler 900 is installed at a perimeter of the racks 1220 and are configured to spray the fluid into the racks 1220. The vertical sidewall sprinklers 900 are positioned such that the deflector 940 extends into the racks 1220 from the perimeter such that the vertical sidewall sprinklers 900 are positioned adjacent and above the commodities 1205 of a respective bay 1225. For example, a portion of the deflector 940 of each vertical sidewall sprinkler 900 is positioned above the commodities 1205. When the racks 1220 are double row racks as shown in FIG. 12B, the vertical sidewall sprinklers 900 can be positioned above a single row of the commodities 1205, or can be positioned above each row (e.g., both rows or all rows) of the commodities. In this way, the vertical sidewall sprinklers 900 are referred to as in-rack sprinklers. Such a configuration helps to simplify the piping installation by avoiding piping within the footprint of the rack structure as compared to in-rack sprinkler systems that utilize pendent sprinklers or upright sprinklers. In some embodiments, each vertical sidewall sprinkler 900 can be positioned within the perimeter of the racks 1220. In some embodiments, each vertical sidewall sprinkler 900 can be positioned just outside of the perimeter of the racks 1220. For example, the vertical sidewall sprinklers 900 can be positioned up to six inches (6 inches) or up to twelve inches (12 inches) from the perimeter of the racks 1220.

The fire protection sprinkler system 1250 reduces the amount of fluid reaching the burning combustibles within the racks 1220 as compared to vertical sidewall sprinklers without the benefit of the present disclosure. For example, the K-factor of 11.2 gpm/(psi)^{1/2} or greater allows for the reduction in the pressure of the fluid needed to provide the amount and coverage of fluid necessary to control a fire condition as compared to vertical sidewall sprinklers without the benefit of the present disclosure.

The racks 1220 are spaced by aisles having an aisle width 1265 of four feet (4 ft.), but the aisle width 1265 may be as small as three feet (3 ft.) or three and a half feet (3.5 ft.). The racks 1220 include a deflector-to-commodity clearance 1270 from the top of the commodities 1205 to the deflector 940 of each vertical sidewall sprinkler 900 of at least three inches (3 in.). The activation temperature of the vertical sidewall sprinkler 900 is two hundred twelve degrees Fahrenheit (212° F.) but may be as low as one hundred fifty-five degrees Fahrenheit (155° F.) and as high as three hundred sixty degrees Fahrenheit (360° F.) depending on the ambient temperature in the space being protected. The discharge pressure of the fluid from the vertical sidewall sprinkler 900 is nominally twenty-nine pounds per square inch (29 psi), buy may be as low as seven pounds per square inch (7 psi) for lower water flow rates and as high as one hundred fifteen pounds per square inch (115 psi) for higher water flow rates.

In operation, at least one of the plurality of vertical sidewall sprinklers 900 is activated in the event of a fire condition sensed by the thermally responsive element 1035 (FIGS. 9 and 10). The fire protection fluid is delivered from the piping network 1251 and output by each of the at least one activated of the plurality of vertical sidewall sprinklers 900 to a coverage area. The coverage area is at least the size (e.g., width and depth) of the one or more bays 1225. In this way, each vertical sidewall sprinkler 900 installed at one face of the rack 1220 (e.g., at the perimeter) provides coverage across the full depth of the rack 1220. For example, each vertical sidewall sprinkler 900 provides coverage across an entirety of the bay width 1226 and an entirety of the storage depth 1228. The vertical sidewall sprinklers 900 output the fire protection fluid vertically and the fire protection fluid impinges on the deflector 940. The deflector 940 directs the fire protection fluid generally horizontally into the rack 1220 and towards the commodities 1205. In particular, the fire protection fluid impinges on the horizontal shelf 945. The first angled portion 970 directs the fire protection fluid along the horizontal shelf 945 and the horizontal shelf 945 directs the fire protection fluid into the rack 1220 and towards the commodities 1205. The second angled portion 976 and the third angled portion 978 help to direct the fire protection fluid along the horizontal shelf 945 and help to prevent the fire protection fluid from flowing beyond the sides of the deflector 940. In this way, the first angled portion 970 and the horizontal shelf 945 of the deflector 940 together direct the fire protection fluid to the coverage area.

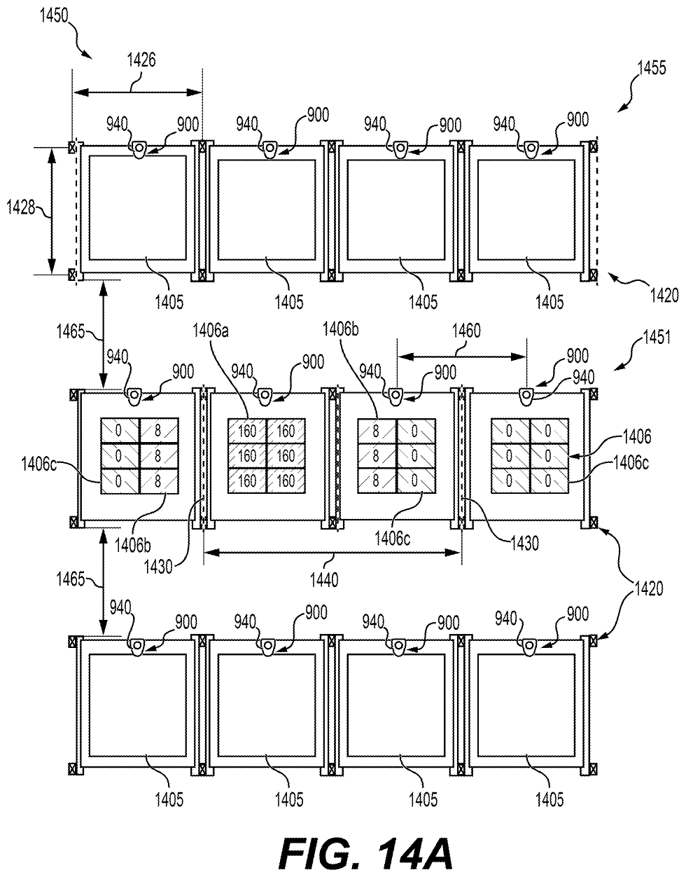

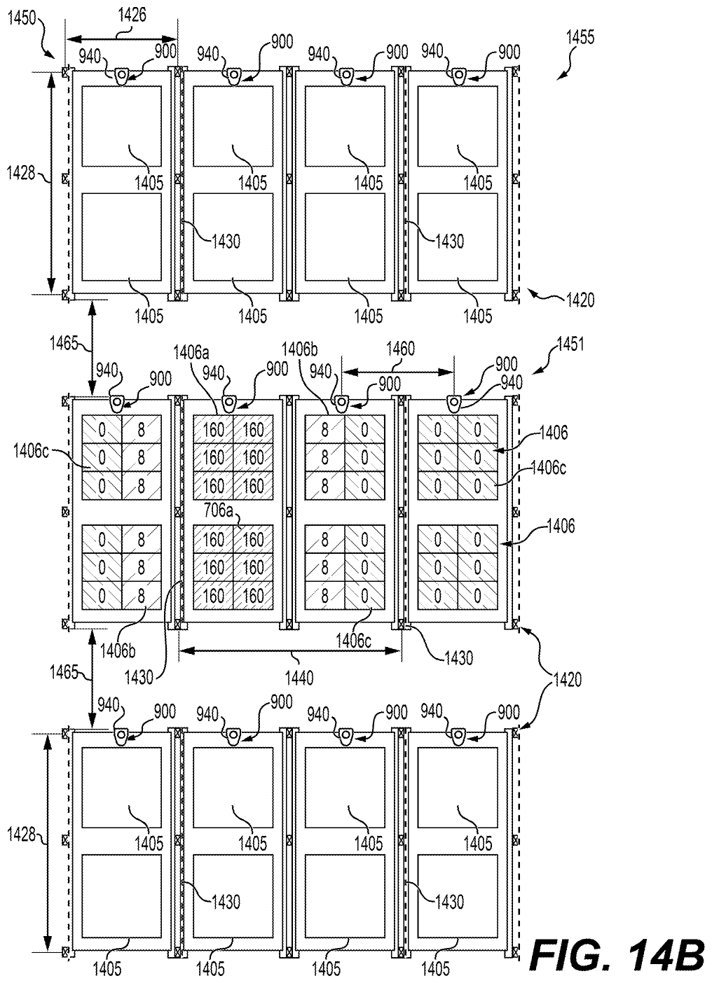

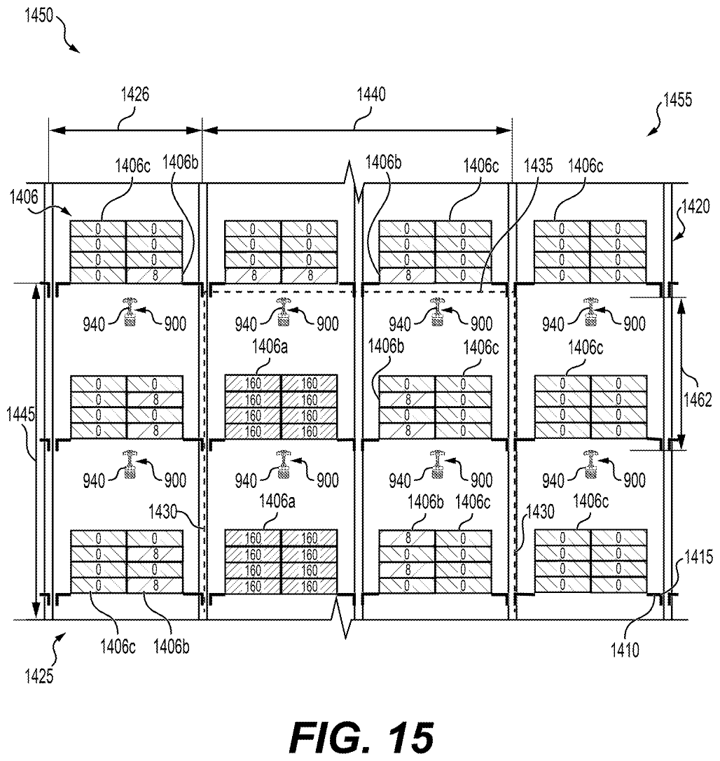

FIG. 14A is a plan view of an arrangement of stored commodities 1405 and high energy commodities 1406, according to the present disclosure. FIG. 14B is a plan view of an arrangement of the stored commodities 1405, according to another embodiment. FIG. 14A shows a single row rack configuration in which there is only a single row of commodities within a respective rack, and FIG. 14B shows a double row rack configuration in which there are two rows of commodities within a respective rack. FIG. 15 is an elevation view of the arrangement of stored commodities 1405 and high energy commodities 1406 shown in FIG. 14A, according to the present disclosure. Rack storage is a conventional storage arrangement used in various industries and facilities, as detailed above. Typically, the commodity 1405 and the high energy commodities 1406 to be protected are placed on a pallet 1410 and are stored on a shelf 1415 in a rack 1420, as shown in FIGS. 14A and 14B. The commodity 1405 includes a cartoned unexpanded plastic (CUP) commodity, but can include any type of commodity detailed above. The high energy commodities 1406 include one or more Lithium-ion battery cells, but can include any type of high energy commodity. For example, the high energy commodities 1406 include one or more first trays 1406a that are full of Lithium-ion battery cells (e.g., “160” cells make a full tray). The high energy commodities 1406 also include one or more second trays 1406b that are partially full of Lithium-ion battery cells (e.g., “8” cells in a partially full tray). The high energy commodities 1406 also include one or more third trays 1406c that are empty (e.g., “0” cells stored therein).

Racks can be single row (e.g., FIG. 14A), double row (e.g., FIG. 14B), or multiple row, with or without solid shelving. Each rack 1420 can include one or more bays 1425 that define columns of the rack 1420. The one or more bays 1425 include a bay width 1426 of three feet (3 ft.), but may range from eighteen inches (18 in.) to eight feet (8 ft.). The racks 1420 include a storage depth 1428 of three feet (3 ft.), but may range from eighteen inches (18 in.) to eight feet (8 ft.).

Each rack 1420 also includes one or more vertical barriers 1430 and one or more horizontal barriers 1435. The one or more vertical barriers 1430 extend vertically along the rack 1420 from a maximum of four inches (4 in.) above the floor to the maximum storage height. The one or more horizontal barriers 1435 extend horizontally along the rack 1420 across two adjacent bays 1425. The one or more vertical barriers 1430 are spaced horizontally (e.g., in the orientation shown in FIGS. 14A, 14B, and 15) from each other at a vertical barrier spacing 1440 of six feet (6 ft, but may range from eighteen inches (18 inches) to ten feet (10 ft.). The one or more horizontal barriers 1435 are spaced vertically (e.g., in the orientation shown in FIGS. 14A, 14B, and 15) from each other at a horizontal barrier spacing 1445 of six feet (6 ft, but may range from two feet (2 ft.) to ten feet (10 ft.).

With reference to FIGS. 14A, 14B, and 15, a fire protection sprinkler system 1450 includes the vertical sidewall sprinklers 900 placed within a room, also referred to as a storage area 1455, with a floor and a ceiling. The storage area 1455 includes one or more racks 1420 for storing one or more commodities 1405 and/or one or more high energy commodities 1406. The fire protection sprinkler system 1450 includes a plurality of vertical sidewall sprinklers 900 connected to a piping network 1451 including one or more pipes. In FIGS. 14A, 14B, and 15, the vertical sidewall sprinklers 900 are arranged in an upright configuration (e.g., extending from a top of the pipes). In some embodiments, the vertical sidewall sprinklers 900 can be arranged in a pendent configuration (e.g., extending from a bottom of the pipes). The piping network 1451 is located outside of the one or more racks 1420. In this way, the one or more pipes of the piping network 1451 are located outside of the one or more racks 1420 and do not extend through, or within, the one or more racks 1420. The vertical sidewall sprinklers 900 are spaced laterally (e.g., horizontally) from each other at a lateral sprinkler spacing 1460 in a range from eighteen inches (18 inches) to ten feet (10 ft.), the horizontal spacing varying depending on the fire hazard of the content being protected. The lateral spacing is needed to allow the adequate water to be discharged from the vertical sidewall sprinklers 900 onto burning contents to allow the fire to be controlled or suppressed. The vertical sidewall sprinklers 900 are spaced vertically from each other at a vertical sprinkler spacing 1462 in a range from two feet (2 ft.) to ten feet (10 ft.). The vertical spacing of the vertical sidewall sprinklers 900 is needed to provide for timely operation of the vertical sidewall sprinklers 900 during a fire condition as well as to allow adequate water discharged by the sprinkler upon operation to reach the burning contents below, with the ability of the water to travel downwards through the fire reduced as the energy released by the fire increases. The vertical sidewall sprinklers 900 are positioned such that the deflector 940 of each vertical sidewall sprinkler 900 is configured to direct the fluid towards the high energy commodities 1406 within the rack 1420. For example, each vertical sidewall sprinkler 900 is installed at a perimeter of the rack 1420 and are configured to spray the fluid into the racks 1420. The vertical sidewall sprinklers 900 are positioned such that the deflector 940 extends into the racks 1420 from the perimeter such that the vertical sidewall sprinklers 900 are positioned adjacent and above the commodities 1405 or the high energy commodities 1406 of a respective bay 1425. For example, the deflector 940 of each vertical sidewall sprinkler 900 is positioned above the commodities 1405 and the high energy commodities 1406. When the racks 1420 are double row racks as shown in FIG. 14B, the vertical sidewall sprinklers 900 can be positioned above a single row of the commodities 1405 or the high energy commodities 1406, or can be positioned above each row (e.g., both rows or all rows) of the commodities or the high energy commodities 1406. In this way, the vertical sidewall sprinklers 900 are referred to as in-rack sprinklers. Such a configuration helps to simplify the piping installation by avoiding piping within the footprint of the rack structure as compared to in-rack sprinkler systems that utilize pendent sprinklers or upright sprinklers. To further direct water discharging from the vertical sidewall sprinklers 900 within the rack structure, the deflector 940 is at an angle between horizontal and forty-five degrees (45°) below horizontal. The fire protection sprinkler system 1450 reduces the amount of fluid reaching the burning combustibles within the racks 1420 as compared to vertical sidewall sprinklers without the benefit of the present disclosure.

The racks 1420 are spaced by aisles having an aisle width 1465 of four feet (4 ft.), but the aisle width may be as small as three feet (3 ft.) or three and a half feet (3.5 ft.). The racks 1420 include a deflector-to-commodity clearance (e.g., the deflector-to-commodity clearance 570) from the top of the high energy commodities 1406 to the deflector 940 of each vertical sidewall sprinkler 900 of at least three inches (3 in.). The activation temperature of the vertical sidewall sprinkler 900 ranges from one hundred fifty-five degrees Fahrenheit (155° F.) to three hundred sixty degrees Fahrenheit (360° F.) and is preferably two hundred twelve degrees Fahrenheit (212° F.). The discharge pressure of the fluid from the vertical sidewall sprinkler 900 ranges from seven pounds per square inch (7 psi) to one hundred fifteen pounds per square inch (115 psi).

In operation, at least one of the plurality of vertical sidewall sprinklers 900 is activated in the event of a fire condition sensed by the thermally responsive element 1035 (FIGS. 9 and 10). The fire protection fluid is delivered from the piping network 1451 and output by each of the at least one activated of the plurality of vertical sidewall sprinklers 900 to a coverage area. The coverage area is at least the size (e.g., width and depth) of the one or more bays 1425. In this way, each vertical sidewall sprinkler 900 installed at one face of the rack 1420 (e.g., at the perimeter) provides coverage across the full depth of the rack 1420. For example, each vertical sidewall sprinkler 900 provides coverage across an entirety of the bay width 1426 and an entirety of the storage depth 1428. The vertical sidewall sprinklers 900 operate as detailed above with respect to FIGS. 12A, 12B, and 13.

Accordingly, the vertical sidewall sprinkler 900 of the present disclosure allows for in-rack sprinklers to be installed where the piping supplying the in-rack sprinklers is located outside of the rack structure. Locating the piping supply the in-rack sprinklers outside of the rack simplifies the installation of the piping and allows for more contents (e.g., stored commodities) to be located within a given volume of rack. The vertical sidewall sprinkler 900 limits the distance that must be maintained between the sprinkler and the contents stored below. Further, the vertical sidewall sprinkler 900 of the present disclosure allows the majority of the water, upon operation of the sprinkler, to be directed towards the contents in the racks and limits the amount of water reaching the aisle adjacent to the rack.

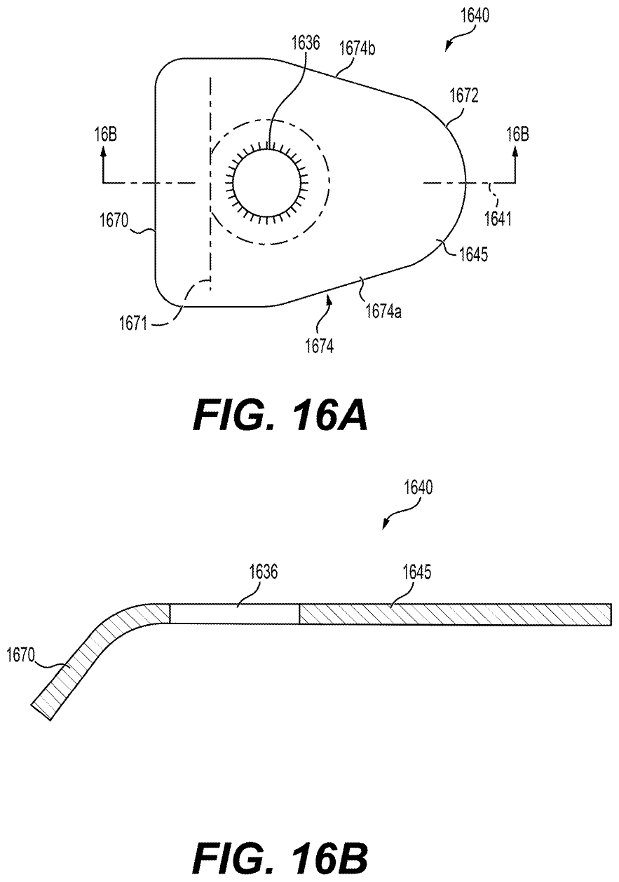

FIG. 16A is a top view of an example deflector 1640 for a vertical sidewall sprinkler, according to another embodiment. FIG. 16B is a cross-sectional side view of the deflector 1640, taken along line 16B-16B in FIG. 16A, according to the present disclosure. The deflector 1640 can be utilized on the vertical sidewall sprinklers 900 of FIGS. 9, 10, and 12A to 15. The deflector 1640 is substantially similar as the deflector 940, but is substantially planar. In particular, the deflector 1640 has a deflector axis 1641 and includes a horizontal shelf 1645 with an opening 1636, and a first angled portion 1670. The deflector 1640 also includes a first bend line 1671, a curve end edge 1672, and straight edge portions 1674 (including a first straight edge portion 1674a and a second straight edge portion 1674b). The deflector 1640, however, does not include a second angled portion or a third angled portion. In this way, the deflector 1640 is substantially planar. The deflector 1640 operates substantially similar as does the deflector 940 of FIGS. 9 to 15. In particular, the first angled portion 1670 directs the fire protection fluid toward the horizontal shelf 1645 and the horizontal shelf 1645 directs the fire protection fluid into the rack and towards the commodities.

Further aspects of the present disclosure are provided by the subject matter of the following clauses.

A fire protection sprinkler system for a storage area for one or more commodities including at least one of Class I to Class IV, Group A cartoned unexpanded plastic commodities, or high energy commodities, the storage area having one or more racks that each include one or more bays, the fire protection sprinkler system comprising (A) a piping network supplied by a source of fire protection fluid provided at the storage area, and (B) a plurality of horizontal sidewall sprinklers, each of the plurality of horizontal sidewall sprinklers having a K-factor of 11.2 gpm/(psi)^{1/2} or greater and being positioned horizontally at a perimeter of the one or more racks to direct the fire protection fluid into the one or more bays, each of the plurality of horizontal sidewall sprinklers including a deflector, the deflector being configured to distribute the fire protection fluid to a coverage area of the storage area.

The fire protection sprinkler system of the preceding clause, wherein the high energy commodities include Lithium-ion batteries.

The fire protection sprinkler system of any preceding clause, wherein the storage area includes the high energy commodities and at least one of the Class I to Class IV or Group A cartoned unexpanded plastic commodities.

The fire protection sprinkler system of any preceding clause, wherein the one or more racks are spaced at an aisle width of three feet to four feet.

The fire protection sprinkler system of any preceding clause, wherein the plurality of horizontal sidewall sprinklers are spaced from the one or more commodities at a deflector-to-commodity clearance of at least three inches.

The fire protection sprinkler system of any preceding clause, wherein the plurality of horizontal sidewall sprinklers are spaced laterally from each other at a lateral sprinkler spacing in a range from eighteen inches to ten feet.

The fire protection sprinkler system of any preceding clause, wherein the plurality of horizontal sidewall sprinklers are spaced vertically from each other at a vertical sprinkler spacing in a range from two feet to ten feet.

The fire protection sprinkler system of any preceding clause, wherein the piping network is located entirely outside of the one or more racks.

The fire protection sprinkler system of any preceding clause, wherein the one or more bays include a bay width of eighteen inches to eight feet.

The fire protection sprinkler system of any preceding clause, wherein the one or more racks include a storage depth of eighteen inches to eight feet.

The fire protection sprinkler system of any preceding clause, wherein each of the plurality of horizontal sidewall sprinklers provides coverage to an entirety of a bay width and a storage depth of the one or more racks.

The fire protection sprinkler system of any preceding clause, wherein each of the plurality of horizontal sidewall sprinklers comprises (a) a body including (i) an inlet orifice at an input end of the body, an outer surface of the input end configured to connect to the piping network, (ii) an outlet orifice at an output end of the body, and (iii) an axial fluid flow passage that extends between the outlet orifice and the inlet orifice, (b) a seal cap that seals the outlet orifice, (c) a first frame arm and a second frame arm that extend from opposite sides of the output end of the body and meet at a hub positioned downstream of the outlet orifice and extend along a fluid flow axis, the first frame arm and the second frame arm forming a plane, (d) a thermally responsive element positioned between the hub and the seal cap, the thermally responsive element being configured to (1) hold the seal cap in the outlet orifice, and (2) release the seal cap when ambient temperature reaches a predetermined temperature, and (e) the deflector mounted to the hub.

The fire protection sprinkler system of any preceding clause, wherein an activation temperature of the plurality of horizontal sidewall sprinklers is from one hundred fifty-five degrees Fahrenheit to three hundred sixty degrees Fahrenheit (155° F. to 360° F.).

The fire protection sprinkler system of the preceding clause, wherein the activation temperature of the plurality of horizontal sidewall sprinklers is two hundred twelve degrees Fahrenheit (212° F.).

The fire protection sprinkler system of any preceding clause, wherein a discharge pressure of the fire protection fluid from the plurality of horizontal sidewall sprinklers is seven pounds per square inch (7 psi) to one hundred fifteen pounds per square inch (115 psi).

The fire protection sprinkler system of any preceding clause, wherein a discharge pressure of the fire protection fluid from the plurality of horizontal sidewall sprinklers is nominally twenty-nine pounds per square inch (29 psi).

The fire protection sprinkler system of any preceding clause, wherein the deflector of each of the plurality of horizontal sidewall sprinklers comprises a horizontal shelf and a vertical face.

The fire protection sprinkler system of the preceding clause, wherein the horizontal shelf of the deflector is angled to direct the fire protection fluid downwards with respect to the vertical face towards the one or more commodities.

The fire protection sprinkler system of the preceding clause, wherein the horizontal shelf of the deflector is angled at an angle of approximately 20° with respect to the vertical face.

The fire protection sprinkler system of the preceding clause, wherein the horizontal shelf of the deflector is angled at an angle up to 450 with respect to the vertical face.

The fire protection sprinkler system of any preceding clause, wherein the plurality of horizontal sidewall sprinklers is positioned above the one or more commodities.

The fire protection sprinkler system of any preceding clause, wherein the deflector of each of the plurality of horizontal sidewall sprinklers is positioned above the one or more commodities.

The fire protection sprinkler system of any preceding clause, further including one or more vertical barriers between the one or more bays of the one or more racks.

The fire protection sprinkler system of the preceding clause, wherein the one or more vertical barriers are spaced horizontally from each other at a vertical barrier spacing of eighteen inches to ten feet.

The fire protection sprinkler system of the preceding clause, wherein the one or more vertical barriers are spaced horizontally from each other at a vertical barrier spacing of six feet.

The fire protection sprinkler system of any preceding clause, further including one or more horizontal barriers between rows of the one or more racks.

The fire protection sprinkler system of the preceding clause, wherein the one or more horizontal barriers are spaced vertically from each other at a horizontal barrier spacing of two feet to ten feet.

The fire protection sprinkler system of the preceding clause, wherein the one or more horizontal barriers are spaced vertically from each other at a horizontal barrier spacing of six feet.

A method of providing a fire protection sprinkler system for a storage area for one or more commodities including at least one of Class I to Class IV, Group A cartoned unexpanded plastic commodities, or high energy commodities, the storage area having one or more racks that each include one or more bays, the method comprising (A) providing a fire protection sprinkler system that includes (a) a piping network supplied by a source of fire protection fluid provided at the storage area, and (b) a plurality of horizontal sidewall sprinklers, each of the plurality of horizontal sidewall sprinklers having a K-factor of 11.2 gpm/(psi)^{1/2} or greater and being positioned horizontally at a perimeter of the one or more racks to direct the fire protection fluid into the one or more bays, each of the plurality of horizontal sidewall sprinklers including a deflector, the deflector being configured to distribute the fire protection fluid to a coverage area of the storage area, (B) installing each of the plurality of horizontal sidewall sprinklers at the storage area so that the deflector of each of the plurality of horizontal sidewall sprinklers is positioned above the one or more commodities, the installing including (a) connecting each of the plurality of horizontal sidewall sprinklers to the piping network, (b) activating at least one of the plurality of horizontal sidewall sprinklers in an event of a fire condition sensed by at least one of the plurality of horizontal sidewall sprinklers, and (c) delivering the fire protection fluid supplied to each of the plurality of horizontal sidewall sprinklers from the piping network, to be output by each of the at least one activated of the plurality of horizontal sidewall sprinklers to the coverage area.

The method of the preceding clause, wherein the high energy commodities include Lithium-ion batteries.

The method of any preceding clause, wherein the storage area includes the high energy commodities and at least one of the Class I to Class IV or Group A cartoned unexpanded plastic commodities.

The method of any preceding clause, wherein the one or more racks are spaced at an aisle width of three feet to four feet.

The method of any preceding clause, wherein the plurality of horizontal sidewall sprinklers are spaced from the one or more commodities at a deflector-to-commodity clearance of at least three inches.

The method of any preceding clause, wherein the plurality of horizontal sidewall sprinklers are spaced laterally from each other at a lateral sprinkler spacing in a range from eighteen inches to ten feet.

The method of any preceding clause, wherein the plurality of horizontal sidewall sprinklers are spaced vertically from each other at a vertical sprinkler spacing in a range from two feet to ten feet.

The method of any preceding clause, wherein the piping network is located entirely outside of the one or more racks.

The method of any preceding clause, wherein the one or more bays include a bay width of eighteen inches to eight feet.

The method of any preceding clause, wherein the one or more racks include a storage depth of eighteen inches to eight feet.

The method of any preceding clause, wherein each of the plurality of horizontal sidewall sprinklers provides coverage to an entirety of a bay width and a storage depth of the one or more racks.

The method of any preceding clause, wherein each of the plurality of horizontal sidewall sprinklers comprises (a) a body including (i) an inlet orifice at an input end of the body, an outer surface of the input end configured to connect to the piping network, (ii) an outlet orifice at an output end of the body, and (iii) an axial fluid flow passage that extends between the outlet orifice and the inlet orifice, (b) a seal cap that seals the outlet orifice, (c) a first frame arm and a second frame arm that extend from opposite sides of the output end of the body and meet at a hub positioned downstream of the outlet orifice and extend along a fluid flow axis, the first frame arm and the second frame arm forming a plane, (d) a thermally responsive element positioned between the hub and the seal cap, the thermally responsive element being configured to (1) hold the seal cap in the outlet orifice, and (2) release the seal cap when ambient temperature reaches a predetermined temperature, and (e) the deflector mounted to the hub.

The method of any preceding clause, wherein an activation temperature of the plurality of horizontal sidewall sprinklers is from one hundred fifty-five degrees Fahrenheit to three hundred sixty degrees Fahrenheit (155° F. to 360° F.).

The method of any preceding clause, wherein an activation temperature of the plurality of horizontal sidewall sprinklers is two hundred twelve degrees Fahrenheit (212° F.).

The method of any preceding clause, wherein a discharge pressure of the fire protection fluid from the plurality of horizontal sidewall sprinklers is seven pounds per square inch (7 psi) to one hundred fifteen pounds per square inch (115 psi).

The method of any preceding clause, wherein a discharge pressure of the fire protection fluid from the plurality of horizontal sidewall sprinklers is nominally twenty-nine pounds per square inch (29 psi).

The method of any preceding clause, wherein the deflector of each of the plurality of horizontal sidewall sprinklers comprises a horizontal shelf and a vertical face.

The method of the preceding clause, wherein the horizontal shelf of the deflector is angled to direct the fire protection fluid downwards with respect to the vertical face towards the one or more commodities.

The method of the preceding clause, wherein the horizontal shelf of the deflector is angled at an angle of approximately 20° with respect to the vertical face.

The method of the preceding clause, wherein the horizontal shelf of the deflector is angled at an angle up to 450 with respect to the vertical face.

The method of any preceding clause, wherein the plurality of horizontal sidewall sprinklers is positioned above the one or more commodities.

The method of any preceding clause, wherein the deflector of each of the plurality of horizontal sidewall sprinklers is positioned above the one or more commodities.

The method of any preceding clause, further including one or more vertical barriers between the one or more bays of the one or more racks.

The method of the preceding clause, wherein the one or more vertical barriers are spaced horizontally from each other at a vertical barrier spacing of eighteen inches to ten feet.

The method of the preceding clause, wherein the one or more vertical barriers are spaced horizontally from each other at a vertical barrier spacing of six feet.

The method of any preceding clause, further including one or more horizontal barriers between rows of the one or more racks.

The method of the preceding clause, wherein the one or more horizontal barriers are spaced vertically from each other at a horizontal barrier spacing of two feet to ten feet.

The method of the preceding clause, wherein the one or more horizontal barriers are spaced vertically from each other at a horizontal barrier spacing of six feet.

A fire protection sprinkler system for a storage area for one or more commodities including at least one of Class I to Class IV, Group A cartoned unexpanded plastic commodities, or high energy commodities, the storage area having one or more racks that each include one or more bays, the fire protection sprinkler system comprising (A) a piping network supplied by a source of fire protection fluid provided at the storage area, and (B) a plurality of vertical sidewall sprinklers, each of the plurality of vertical sidewall sprinklers having a K-factor of 11.2 gpm/(psi)^{1/2} or greater and being positioned vertically at a perimeter of the one or more racks to direct the fire protection fluid into the one or more bays, each of the plurality of vertical sidewall sprinklers including a deflector, the deflector being configured to distribute the fire protection fluid into the one or more bays to a coverage area of the storage area.

The fire protection sprinkler system of the preceding clause, wherein the high energy commodities include Lithium-ion batteries.

The fire protection sprinkler system of any preceding clause, wherein the storage area includes the high energy commodities and at least one of the Class I to Class IV or Group A cartoned unexpanded plastic commodities.

The fire protection sprinkler system of any preceding clause, wherein the one or more racks are spaced at an aisle width of three feet to four feet.

The fire protection sprinkler system of any preceding clause, wherein the plurality of vertical sidewall sprinklers are spaced from the one or more commodities at a deflector-to-commodity clearance of at least three inches.

The fire protection sprinkler system of any preceding clause, wherein the plurality of vertical sidewall sprinklers are spaced laterally from each other at a lateral sprinkler spacing in a range from eighteen inches to ten feet.

The fire protection sprinkler system of any preceding clause, wherein the plurality of vertical sidewall sprinklers are spaced vertically from each other at a vertical sprinkler spacing in a range from two feet to ten feet.

The fire protection sprinkler system of any preceding clause, wherein the piping network is located entirely outside of the one or more racks.

The fire protection sprinkler system of any preceding clause, wherein the one or more bays include a bay width of eighteen inches to eight feet.

The fire protection sprinkler system of any preceding clause, wherein the one or more racks include a storage depth of eighteen inches to eight feet.

The fire protection sprinkler system of any preceding clause, wherein each of the plurality of vertical sidewall sprinklers provides coverage to an entirety of a bay width and a storage depth of the one or more racks.

The fire protection sprinkler system of any preceding clause, wherein each of the plurality of vertical sidewall sprinklers comprises (a) a body including (i) an inlet orifice at an input end of the body, an outer surface of the input end configured to connect to the piping network, (ii) an outlet orifice at an output end of the body, and (iii) an axial fluid flow passage that extends between the outlet orifice and the inlet orifice, (b) a seal cap that seals the outlet orifice, (c) a first frame arm and a second frame arm that extend from opposite sides of the output end of the body and meet at a hub positioned downstream of the outlet orifice and extend along a fluid flow axis, the first frame arm and the second frame arm forming a plane, (d) a thermally responsive element positioned between the hub and the seal cap, the thermally responsive element being configured to (1) hold the seal cap in the outlet orifice, and (2) release the seal cap when ambient temperature reaches a predetermined temperature, and (e) the deflector mounted to the hub.

The fire protection sprinkler system of any preceding clause, wherein an activation temperature of the plurality of vertical sidewall sprinklers is from one hundred fifty-five degrees Fahrenheit to three hundred sixty degrees Fahrenheit (155° F. to 360° F.).

The fire protection sprinkler system of any preceding clause, wherein the activation temperature of the plurality of vertical sidewall sprinklers is two hundred twelve degrees Fahrenheit (212° F.).

The fire protection sprinkler system of any preceding clause, wherein a discharge pressure of the fire protection fluid from the plurality of vertical sidewall sprinklers is seven pounds per square inch (7 psi) to one hundred fifteen pounds per square inch (115 psi).

The fire protection sprinkler system of any preceding clause, wherein a discharge pressure of the fire protection fluid from the plurality of vertical sidewall sprinklers is nominally twenty-nine pounds per square inch (29 psi).

The fire protection sprinkler system of any preceding clause, wherein the deflector of each of the plurality of vertical sidewall sprinklers comprises a horizontal shelf and a first angled portion.

The fire protection sprinkler system of the preceding clause, wherein the horizontal shelf of the deflector is angled to direct the fire protection fluid downwards with respect to a deflector axis towards the one or more commodities.

The fire protection sprinkler system of the preceding clause, wherein the horizontal shelf of the deflector is angled at an angle of approximately 20° with respect to the deflector axis.

The fire protection sprinkler system of the preceding clause, wherein the horizontal shelf of the deflector is angled at an angle up to 450 with respect to the deflector axis.

The fire protection sprinkler system of any preceding clause, wherein the plurality of vertical sidewall sprinklers is positioned above the one or more commodities.

The fire protection sprinkler system of any preceding clause, wherein the deflector of each of the plurality of vertical sidewall sprinklers is positioned above the one or more commodities.

The fire protection sprinkler system of any preceding clause, further including one or more vertical barriers between the one or more bays of the one or more racks.

The fire protection sprinkler system of the preceding clause, wherein the one or more vertical barriers are spaced horizontally from each other at a vertical barrier spacing of eighteen inches to ten feet.

The fire protection sprinkler system of the preceding clause, wherein the one or more vertical barriers are spaced horizontally from each other at a vertical barrier spacing of six feet.

The fire protection sprinkler system of any preceding clause, further including one or more horizontal barriers between rows of the one or more racks.

The fire protection sprinkler system of the preceding clause, wherein the one or more horizontal barriers are spaced vertically from each other at a horizontal barrier spacing of two feet to ten feet.

The fire protection sprinkler system of the preceding clause, wherein the one or more horizontal barriers are spaced vertically from each other at a horizontal barrier spacing of six feet.

A method of providing a fire protection sprinkler system for a storage area for one or more commodities including at least one of Class I to Class IV, Group A cartoned unexpanded plastic commodities, or high energy commodities, the storage area having one or more racks that each include one or more bays, the method comprising (A) providing a fire protection sprinkler system that includes (a) a piping network supplied by a source of fire protection fluid provided at the storage area, and (b) a plurality of vertical sidewall sprinklers, each of the plurality of vertical sidewall sprinklers having a K-factor of 11.2 gpm/(psi)^{1/2} or greater and being positioned vertically at a perimeter of the one or more racks to direct the fire protection fluid into the one or more bays, each of the plurality of vertical sidewall sprinklers including a deflector, the deflector being configured to distribute the fire protection fluid into the one or more bays to a coverage area of the storage area, (B) installing each of the plurality of vertical sidewall sprinklers at the storage area so that the deflector of each of the plurality of vertical sidewall sprinklers is positioned above the one or more commodities, the installing including (a) connecting each of the plurality of vertical sidewall sprinklers to the piping network, (b) activating at least one of the plurality of vertical sidewall sprinklers in an event of a fire condition sensed by at least one of the plurality of vertical sidewall sprinklers, and (c) delivering the fire protection fluid supplied to each of the plurality of vertical sidewall sprinklers from the piping network, to be output by each of the at least one activated of the plurality of vertical sidewall sprinklers to the coverage area.

The method of the preceding clause, wherein the high energy commodities include Lithium-ion batteries.

The method of any preceding clause, wherein the storage area includes the high energy commodities and at least one of the Class I to Class IV or Group A cartoned unexpanded plastic commodities.

The method of any preceding clause, wherein the one or more racks are spaced at an aisle width of three feet to four feet.

The method of any preceding clause, wherein the plurality of vertical sidewall sprinklers are spaced from the one or more commodities at a deflector-to-commodity clearance of at least three inches.

The method of any preceding clause, wherein the plurality of vertical sidewall sprinklers are spaced laterally from each other at a lateral sprinkler spacing in a range from eighteen inches to ten feet.

The method of any preceding clause, wherein the plurality of vertical sidewall sprinklers are spaced vertically from each other at a vertical sprinkler spacing in a range from two feet to ten feet.

The method of any preceding clause, wherein the piping network is located entirely outside of the one or more racks.

The method of any preceding clause, wherein the one or more bays include a bay width of eighteen inches to eight feet.

The method of any preceding clause, wherein the one or more racks include a storage depth of eighteen inches to eight feet.

The method of any preceding clause, wherein each of the plurality of vertical sidewall sprinklers provides coverage to an entirety of a bay width and a storage depth of the one or more racks.

The method of any preceding clause, wherein each of the plurality of vertical sidewall sprinklers comprises (a) a body including (i) an inlet orifice at an input end of the body, an outer surface of the input end configured to connect to the piping network, (ii) an outlet orifice at an output end of the body, and (iii) an axial fluid flow passage that extends between the outlet orifice and the inlet orifice, (b) a seal cap that seals the outlet orifice, (c) a first frame arm and a second frame arm that extend from opposite sides of the output end of the body and meet at a hub positioned downstream of the outlet orifice and extend along a fluid flow axis, the first frame arm and the second frame arm forming a plane, (d) a thermally responsive element positioned between the hub and the seal cap, the thermally responsive element being configured to (1) hold the seal cap in the outlet orifice, and (2) release the seal cap when ambient temperature reaches a predetermined temperature, and (e) the deflector mounted to the hub.

The method of any preceding clause, wherein an activation temperature of the plurality of vertical sidewall sprinklers is from one hundred fifty-five degrees Fahrenheit to three hundred sixty degrees Fahrenheit (155° F. to 360° F.).

The method of any preceding clause, wherein an activation temperature of the plurality of vertical sidewall sprinklers is two hundred twelve degrees Fahrenheit (212° F.).

The method of any preceding clause, wherein a discharge pressure of the fire protection fluid from the plurality of vertical sidewall sprinklers is seven pounds per square inch (7 psi) to one hundred fifteen pounds per square inch (115 psi).

The method of any preceding clause, wherein a discharge pressure of the fire protection fluid from the plurality of vertical sidewall sprinklers is nominally twenty-nine pounds per square inch (29 psi).

The method of any preceding clause, wherein the deflector of each of the plurality of vertical sidewall sprinklers comprises a horizontal shelf and a first angled portion.

The method of the preceding clause, wherein the horizontal shelf of the deflector is angled to direct the fire protection fluid downwards with respect to a sprinkler axis towards the one or more commodities.

The method of the preceding clause, wherein the horizontal shelf of the deflector is angled at an angle of approximately 20° with respect to the sprinkler axis.

The method of the preceding clause, wherein the horizontal shelf of the deflector is angled at an angle up to 450 with respect to the sprinkler axis.

The method of any preceding clause, wherein the plurality of vertical sidewall sprinklers is positioned above the one or more commodities.

The method of any preceding clause, wherein the deflector of each of the plurality of vertical sidewall sprinklers is positioned above the one or more commodities.

The method of any preceding clause, further including one or more vertical barriers between the one or more bays of the one or more racks.

The method of the preceding clause, wherein the one or more vertical barriers are spaced horizontally from each other at a vertical barrier spacing of eighteen inches to ten feet.

The method of the preceding clause, wherein the one or more vertical barriers are spaced horizontally from each other at a vertical barrier spacing of six feet.

The method of any preceding clause, further including one or more horizontal barriers between rows of the one or more racks.

The method of the preceding clause, wherein the one or more horizontal barriers are spaced vertically from each other at a horizontal barrier spacing of two feet to ten feet.

The method of the preceding clause, wherein the one or more horizontal barriers are spaced vertically from each other at a horizontal barrier spacing of six feet.

Although the foregoing description is directed to the preferred embodiments of the present disclosure, other variations and modifications will be apparent to one with skill in the art that the storage fire protection sprinklers of the invention may be provided using some or all of the mentioned features and components without departing from the spirit and the scope of the present invention. Also, the embodiments described above are specific examples of a single broader invention that may have greater scope than any of the singular descriptions taught. There may be many alterations made in the descriptions without departing from the spirit and the scope of the present invention. Moreover, features described in connection with one embodiment of the present disclosure may be used in conjunction with other embodiments, even if not explicitly stated above.

1. A fire protection sprinkler system for a storage area for one or more commodities including at least one of Class I to Class IV, Group A cartoned unexpanded plastic commodities, or high energy commodities, the storage area having one or more racks that each include one or more bays, the fire protection sprinkler system comprising:
(A) a piping network supplied by a source of fire protection fluid provided at the storage area; and
(B) a plurality of horizontal sidewall sprinklers, each of the plurality of horizontal sidewall sprinklers having a K-factor of 11.2 gpm/(psi)^{1/2} or greater and being positioned horizontally at a perimeter of the one or more racks to direct the fire protection fluid into the one or more bays, each of the plurality of horizontal sidewall sprinklers including a deflector, the deflector being configured to distribute the fire protection fluid to a coverage area of the storage area.

2. The fire protection sprinkler system of claim 1, wherein the high energy commodities include Lithium-ion batteries.

3. The fire protection sprinkler system of claim 1, wherein the storage area includes the high energy commodities and at least one of the Class I to Class IV or Group A cartoned unexpanded plastic commodities.

4. The fire protection sprinkler system of claim 1, wherein the one or more racks are spaced at an aisle width of three feet to four feet.

5. The fire protection sprinkler system of claim 1, wherein the plurality of horizontal sidewall sprinklers are spaced from the one or more commodities at a deflector-to-commodity clearance of at least three inches.

6. The fire protection sprinkler system of claim 1, wherein the plurality of horizontal sidewall sprinklers are spaced laterally from each other at a lateral sprinkler spacing in a range from eighteen inches to ten feet.

7. The fire protection sprinkler system of claim 1, wherein the plurality of horizontal sidewall sprinklers are spaced vertically from each other at a vertical sprinkler spacing in a range from two feet to ten feet.

8. The fire protection sprinkler system of claim 1, wherein the piping network is located entirely outside of the one or more racks.

9. The fire protection sprinkler system of claim 1, wherein the one or more bays include a bay width of eighteen inches to eight feet.

10. The fire protection sprinkler system of claim 1, wherein the one or more racks include a storage depth of eighteen inches to eight feet.

11. The fire protection sprinkler system of claim 1, wherein each of the plurality of horizontal sidewall sprinklers provides coverage to an entirety of a bay width and a storage depth of the one or more racks.

12. The fire protection sprinkler system of claim 1, wherein each of the plurality of horizontal sidewall sprinklers comprises:
(a) a body including:
(i) an inlet orifice at an input end of the body, an outer surface of the input end configured to connect to the piping network;
(ii) an outlet orifice at an output end of the body; and
(iii) an axial fluid flow passage that extends between the outlet orifice and the inlet orifice;
(b) a seal cap that seals the outlet orifice;
(c) a first frame arm and a second frame arm that extend from opposite sides of the output end of the body and meet at a hub positioned downstream of the outlet orifice and extend along a fluid flow axis, the first frame arm and the second frame arm forming a plane;
(d) a thermally responsive element positioned between the hub and the seal cap, the thermally responsive element being configured (1) to hold the seal cap in the outlet orifice, and (2) to release the seal cap when ambient temperature reaches a predetermined temperature; and
(e) the deflector mounted to the hub.

13. The fire protection sprinkler system of claim 1, wherein an activation temperature of the plurality of horizontal sidewall sprinklers is from one hundred fifty-five degrees Fahrenheit to three hundred sixty degrees Fahrenheit (155° F. to 360° F.).

14. The fire protection sprinkler system of claim 13, wherein the activation temperature of the plurality of horizontal sidewall sprinklers is two hundred twelve degrees Fahrenheit (212° F.).

15. The fire protection sprinkler system of claim 1, wherein a discharge pressure of the fire protection fluid from the plurality of horizontal sidewall sprinklers is seven pounds per square inch (7 psi) to one hundred fifteen pounds per square inch (115 psi).

16. The fire protection sprinkler system of claim 15, wherein a discharge pressure of the fire protection fluid from the plurality of horizontal sidewall sprinklers is nominally twenty-nine pounds per square inch (29 psi).

17. The fire protection sprinkler system of claim 1, wherein the deflector of each of the plurality of horizontal sidewall sprinklers comprises a horizontal shelf and a vertical face.

18. The fire protection sprinkler system of claim 17, wherein the horizontal shelf of the deflector is angled to direct the fire protection fluid downwards with respect to the vertical face towards the one or more commodities.

19. The fire protection sprinkler system of claim 18, wherein the horizontal shelf of the deflector is angled at an angle of approximately 20° with respect to the vertical face.

20. The fire protection sprinkler system of claim 18, wherein the horizontal shelf of the deflector is angled at an angle up to 450 with respect to the vertical face.

21. The fire protection sprinkler system of claim 1, wherein the plurality of horizontal sidewall sprinklers is positioned above the one or more commodities.

22. The fire protection sprinkler system of claim 21, wherein the deflector of each of the plurality of horizontal sidewall sprinklers is positioned above the one or more commodities.

23. The fire protection sprinkler system of claim 1, further including one or more vertical barriers between the one or more bays of the one or more racks.

24. The fire protection sprinkler system of claim 23, wherein the one or more vertical barriers are spaced horizontally from each other at a vertical barrier spacing of eighteen inches to ten feet.

25. The fire protection sprinkler system of claim 24, wherein the one or more vertical barriers are spaced horizontally from each other at a vertical barrier spacing of six feet.

26. The fire protection sprinkler system of claim 1, further including one or more horizontal barriers between rows of the one or more racks.

27. The fire protection sprinkler system of claim 26, wherein the one or more horizontal barriers are spaced vertically from each other at a horizontal barrier spacing of two feet to ten feet.

28. The fire protection sprinkler system of claim 27, wherein the one or more horizontal barriers are spaced vertically from each other at a horizontal barrier spacing of six feet.

29. A method of providing a fire protection sprinkler system for a storage area for one or more commodities including at least one of Class I to Class IV, Group A cartoned unexpanded plastic commodities, or high energy commodities, the storage area having one or more racks that each include one or more bays, the method comprising:
(A) providing a fire protection sprinkler system that includes:
(a) a piping network supplied by a source of fire protection fluid provided at the storage area; and
(b) a plurality of horizontal sidewall sprinklers, each of the plurality of horizontal sidewall sprinklers having a K-factor of 11.2 gpm/(psi)^{1/2} or greater and being positioned horizontally at a perimeter of the one or more racks to direct the fire protection fluid into the one or more bays, each of the plurality of horizontal sidewall sprinklers including a deflector, the deflector being configured to distribute the fire protection fluid to a coverage area of the storage area;
(B) installing each of the plurality of horizontal sidewall sprinklers at the storage area so that the deflector of each of the plurality of horizontal sidewall sprinklers is positioned above the one or more commodities, the installing including:
(a) connecting each of the plurality of horizontal sidewall sprinklers to the piping network;
(b) activating at least one of the plurality of horizontal sidewall sprinklers in an event of a fire condition sensed by at least one of the plurality of horizontal sidewall sprinklers; and
(c) delivering the fire protection fluid supplied to each of the plurality of horizontal sidewall sprinklers from the piping network, to be output by each of the at least one activated of the plurality of horizontal sidewall sprinklers to the coverage area.

30. The method of claim 29, wherein the high energy commodities include Lithium-ion batteries.

31. The method of claim 29, wherein the storage area includes the high energy commodities and at least one of the Class I to Class IV or Group A cartoned unexpanded plastic commodities.

32. The method of claim 29, wherein the one or more racks are spaced at an aisle width of three feet to four feet.

33. The method of claim 29, wherein the plurality of horizontal sidewall sprinklers are spaced from the one or more commodities at a deflector-to-commodity clearance of at least three inches.

34. The method of claim 29, wherein the plurality of horizontal sidewall sprinklers are spaced laterally from each other at a lateral sprinkler spacing in a range from eighteen inches to ten feet.

35. The method of claim 29, wherein the plurality of horizontal sidewall sprinklers are spaced vertically from each other at a vertical sprinkler spacing in a range from two feet to ten feet.

36. The method of claim 29, wherein the piping network is located entirely outside of the one or more racks.

37. The method of claim 29, wherein the one or more bays include a bay width of eighteen inches to eight feet.

38. The method of claim 29, wherein the one or more racks include a storage depth of eighteen inches to eight feet.

39. The method of claim 29, wherein each of the plurality of horizontal sidewall sprinklers provides coverage to an entirety of a bay width and a storage depth of the one or more racks.

40. The method of claim 29, wherein each of the plurality of horizontal sidewall sprinklers comprises:
(a) a body including:
(i) an inlet orifice at an input end of the body, an outer surface of the input end configured to connect to the piping network;
(ii) an outlet orifice at an output end of the body; and
(iii) an axial fluid flow passage that extends between the outlet orifice and the inlet orifice;
(b) a seal cap that seals the outlet orifice;
(c) a first frame arm and a second frame arm that extend from opposite sides of the output end of the body and meet at a hub positioned downstream of the outlet orifice and extend along a fluid flow axis, the first frame arm and the second frame arm forming a plane;
(d) a thermally responsive element positioned between the hub and the seal cap, the thermally responsive element being configured (1) to hold the seal cap in the outlet orifice, and
(2) to release the seal cap when ambient temperature reaches a predetermined temperature; and
(e) the deflector mounted to the hub.

41. The method of claim 29, wherein an activation temperature of the plurality of horizontal sidewall sprinklers is from one hundred fifty-five degrees Fahrenheit to three hundred sixty degrees Fahrenheit (155° F. to 360° F.).

42. The method of claim 41, wherein an activation temperature of the plurality of horizontal sidewall sprinklers is two hundred twelve degrees Fahrenheit (212° F.).

43. The method of claim 29, wherein a discharge pressure of the fire protection fluid from the plurality of horizontal sidewall sprinklers is seven pounds per square inch (7 psi) to one hundred fifteen pounds per square inch (115 psi).

44. The method of claim 43, wherein a discharge pressure of the fire protection fluid from the plurality of horizontal sidewall sprinklers is nominally twenty-nine pounds per square inch (29 psi).

45. The method of claim 29, wherein the deflector of each of the plurality of horizontal sidewall sprinklers comprises a horizontal shelf and a vertical face.

46. The method of claim 45, wherein the horizontal shelf of the deflector is angled to direct the fire protection fluid downwards with respect to the vertical face towards the one or more commodities.

47. The method of claim 46, wherein the horizontal shelf of the deflector is angled at an angle of approximately 20° with respect to the vertical face.

48. The method of claim 46, wherein the horizontal shelf of the deflector is angled at an angle up to 450 with respect to the vertical face.

49. The method of claim 29, wherein the plurality of horizontal sidewall sprinklers is positioned above the one or more commodities.

50. The method of claim 49, wherein the deflector of each of the plurality of horizontal sidewall sprinklers is positioned above the one or more commodities.

51. The method of claim 29, further including one or more vertical barriers between the one or more bays of the one or more racks.

52. The method of claim 51, wherein the one or more vertical barriers are spaced horizontally from each other at a vertical barrier spacing of eighteen inches to ten feet.

53. The method of claim 52, wherein the one or more vertical barriers are spaced horizontally from each other at a vertical barrier spacing of six feet.

54. The method of claim 29, further including one or more horizontal barriers between rows of the one or more racks.

55. The method of claim 54, wherein the one or more horizontal barriers are spaced vertically from each other at a horizontal barrier spacing of two feet to ten feet.

56. The method of claim 55, wherein the one or more horizontal barriers are spaced vertically from each other at a horizontal barrier spacing of six feet.
